(19) United States
(12) Patent Application Publication
(10) Pub. No.: US 2014/0126324 A1
(43) Pub. Date: May 8, 2014

(54) ACOUSTO-OPTIC IMAGE CAPTURE DEVICE

(71) Applicant: Panasonic Corporation, Osaka (JP)

(72) Inventors: Ushio SANGAWA, Nara (JP); Takuya IWAMOTO, Osaka (JP); Yuriko KANEKO, Nara (JP); Takahiro KAMAI, Kyoto (JP); Masahiko HASHIMOTO, Osaka (JP)

(73) Assignee: Panasonic Corporation, Osaka (JP)

(21) Appl. No.: 14/107,206

(22) Filed: Dec. 16, 2013

Related U.S. Application Data
(63) Continuation of application No. PCT/JP2013/002452, filed on Apr. 10, 2013.

(30) Foreign Application Priority Data
Apr. 19, 2012 (JP) 2012-095835

(51) Int. Cl. G02F 1/33

(52) U.S. Cl. CPC G02F 1/33
USPC 367/7

(57) ABSTRACT

An acousto-optic image capture device includes: an acoustic beam source, an acoustic lens system; an acousto-optic medium portion arranged on the path of the scattered wave transmitted through the acoustic lens system; a light source that emits a light beam including monochromatic rays of light toward the acousto-optic medium portion obliquely; an imaging lens system that condenses diffracted rays of light produced by the acousto-optic medium; and an image receiving section that detects the rays of light condensed by the imaging lens system. The acoustic lens system includes at least a telecentric acoustic system and a sound-collecting acoustic system arranged on the image space. The distance between acoustic systems is equal to the sum of the respective focal lengths of the telecentric acoustic system and the sound-collecting acoustic system. The light beam is transmitted at the focal point of the sound-collecting acoustic system through the acousto-optic medium portion.

This is a continuation of International Application No. PCT/JP2013/002452, with an international filing date of Apr. 10, 2013, which claims priority of Japanese Patent Application No. 2012-095835, filed on Apr. 19, 2012, the contents of which are hereby incorporated by reference.

### BACKGROUND

1. Technical Field

The present application relates to an acousto-optic image capture device which shoots a subject using light and acoustic waves.

2. Description of the Related Art

If a subject is irradiated with an acoustic wave and if a scattered wave generated is introduced into an acousto-optic medium portion, the density of the medium in the acousto-optic medium portion becomes inhomogeneous to form a refractive index distribution, because the acoustic wave is a longitudinal wave. That is why if light is made to propagate through the acousto-optic medium portion, diffracted light will be produced due to the influence of that refractive index distribution. That is to say, by observing the diffracted light produced, the subject can be detected.

A. Korpel, “Visualization of the Cross Section of a Sound Beam by Bragg Diffraction of Light,” Applied Physics Letters, Vol. 9, No. 12, pp. 425-427, 15 Dec. 1966 (hereinafter called “Non-Patent Document No. 1”) discloses a technique for capturing an image of a subject by producing Bragg diffracted light by irradiating a refractive index distribution produced in an acousto-optic medium portion with monochromatic ray of lights. As shown in FIG. 26, Non-Patent Document No. 1 discloses a technique for projecting an image of a subject 1109 onto a screen 1105 using a He—Ne laser 1101 and an ultrasonic transducer 1111. A monochromatic light beam emitted from the He—Ne laser 1101 is transformed into a monochromatic light beam with an increased beam diameter through a beam expander 1102 and an aperture 1103. If the xyz axes are set as shown in FIG. 26, the monochromatic light beam is transmitted through two cylindrical lenses 1104(a) and 1104(b) which are extended in the x-axis direction and another cylindrical lens 1104(c) which is extended in the y-axis direction to reach the screen 1105. Such an optical system including three cylindrical lenses is not rotationally symmetric with respect to the optical axis 1113.

An acoustic cell 1108 filled with water 1107 is arranged between the cylindrical lenses 1104(a) and 1104(b). And the subject 1109 is arranged in the water 1107. As will be described later, when the monochromatic light beam is transmitted through the water 1107, diffracted light is produced. The diffracted light thus produced has significant astigmatism. That is why to correct the astigmatism of the diffracted light produced and to image the diffracted light at the screen 1105 on xz and yz planes, the cylindrical lenses 1104(a), 1104(b) and 1104(c) have mutually different focal lengths.

The cylindrical lens 1104(a) has its focal length selected so that the monochromatic light beam is focused on an xz plane at the position of a focal plane 1106. Since the monochromatic light beam is imaged by the cylindrical lens, the focal point is a line that is parallel to the x-axis. The light beam that passed through the focal plane 1106 diverges at a position which is closer to the screen 1105 than to the focal plane 1106. However, the divergent light beam gets converged by the cylindrical lens 1104(b) and focused on the screen 1105 again. In the yz plane, the monochromatic light beam that has passed through the beam expander 1102 is incident on the cylindrical lens 1104(c) as a parallel light beam. Then, due to the condensing function of the cylindrical lens 1104(c), the light beam is focused on the screen 1105. The positions and focal lengths of the respective cylindrical lenses are determined so that the light beam is focused on the screen 1105 on both the xz plane and the yz plane and that an image similar to the subject 1109 appears as a first-order diffracted image 1112(a) and −first-order diffracted image 1112(b) on the screen 1105. As described above, since the optical system is not rotationally symmetric with respect to the optical axis 1113, the first-order diffracted image 1112(a) and the −first-order diffracted image 1112(b) have astigmatism. That is why by forming an optical system, of which the aberration is opposite to that of the diffracted light, using the cylindrical lenses 1104(b) and 1104(c), the aberration of the diffracted light is corrected and an image which is similar to the subject 1109 is cast onto the screen 1105.

The acoustic cell 1108 is provided with an ultrasonic transducer 1111 to be driven by a signal source 1110. And the subject 1109 is irradiated with a monotonic ultrasonic wave by the ultrasonic transducer 1111 through the water 1107. In this description, the “monotonic ultrasonic wave” refers herein to an ultrasonic wave, of which the acoustic pressure exhibits a single-frequency sinusoidal variation with time.

An ultrasonic scattered wave is generated from the subject 1109 and propagates through a monochromatic light beam passing region in the water 1107. As the propagation mode of an ultrasonic wave propagating through water is a compressional wave (longitudinal wave), the acoustic pressure distribution in the water 1107, i.e., a refractive index distribution that agrees with the ultrasonic scattered wave, is formed in the water 1107. To simplify the discussion, the scattered ultrasonic wave coming from the subject 1109 is supposed to be a plane wave traveling in the positive y-axis direction. Since the ultrasonic scattered wave is monotonic, the refractive index distribution formed at a moment in the water 1107 becomes a sinusoidal one-dimensional lattice to be repeated at the wavelength of the ultrasonic wave. Consequently, Bragg diffracted light (which is represented as ±first-order diffracted light beams on the drawings) is produced by the one-dimensional lattice. And the diffracted light appears as a single light spot on the screen 1105. The luminance of the spot is proportional to the variation in the refractive index of the one-dimensional lattice, i.e., the acoustic pressure of the ultrasonic wave.

Next, let us relax the condition that the ultrasonic scattered wave is supposed to be a plane wave and imagine an ultrasonic scattered wave, of which the wavefront is not plane. Such an ultrasonic scattered wave, of which the wavefront is not plane, can be represented as a superposition of a plurality of plane waves coming from various directions (all of which are supposed to have the same frequency in this case). That is why if a monochromatic light beam is transmitted through the water 1107 in which such an scattered ultrasonic wave, of which the wavefront is not plane, propagates, then spots of diffracted ray of lights produced by those plane waves coming from various directions will appear on the screen 1105. The intensities of the respective spots are proportional to the amplitudes of the respective plane waves. And the points of appearance of the respective radiants on the screen 1105 are determined by the traveling directions of those plane waves. That is why real images of the subject 1109 appear as ±first-order diffracted images 1112(a) and 1112(b) on the screen 1105. The set of those spots on the screen 1105 can be regarded as the actual image of the subject 1109, because what the subject is to the ±first-order diffracted images, the subject in a general optical camera is to its real image, except that this is a diffraction phenomenon.

### SUMMARY

The present inventors made an intensive research on the technique disclosed in Non-Patent Document No. 1. As a result, the present inventors discovered that only an imaging performance, which was even lower than the resolution to be determined by the wavelength of an ultrasonic wave to use, was realized and the field of view was narrow.

A non-limiting, exemplary embodiment of the present application provides an acousto-optic image capture device which can shoot a subject with a high resolution and in a wide field of view.

An acousto-optic image capture device according to the present disclosure includes: an acoustic wave source; an acoustic lens system configured to transform a scattered wave created by irradiating a subject with an acoustic wave that has been emitted from the acoustic wave source into a predetermined converged state; an acousto-optic medium portion arranged so that the scattered wave that has been transmitted through the acoustic lens system is incident on the acousto-optic medium portion; a light source configured to emit a light beam in which a plurality of monochromatic ray of lights with mutually different traveling directions are superposed one upon the other and which is incident on the acousto-optic medium portion at an angle with respect to, and neither perpendicularly nor parallel to, the acoustic beam axis of the acoustic lens system; an imaging lens system configured to condense diffracted ray of lights of the plurality of monochromatic plane waves ray of lights that have been produced by the acousto-optic medium portion; and an image receiving section configured to detect the ray of lights that have been condensed by the imaging lens system and output an electrical signal. The acoustic lens system includes at least a telecentric acoustic system that is image-space telecentric and a sound-collecting acoustic system that is arranged on the image space. The distance between the telecentric acoustic system and the sound-collecting acoustic system is equal to the sum of the respective focal lengths of the telecentric acoustic system and the sound-collecting acoustic system. The light beam is transmitted at the focal point of the sound-collecting acoustic system through the acousto-optic medium portion.

In an acousto-optic image capture device according to an exemplary embodiment of the present disclosure, an ultrasonic scattered wave created by a subject is transformed into a superposed wave of plane acoustic waves by an acoustic lens system and introduced into an acousto-optic medium portion, gets a light beam, in which a plurality of monochromatic ray of lights with mutually different traveling directions are superposed one upon the other, transmitted through the acousto-optic medium portion, and produces diffracted light based on the distribution of refractive indices that has been caused in the acousto-optic medium portion. As a result, a high-resolution image with little off-axis aberrations can be obtained. In addition, since the acoustic lens system includes a telecentric acoustic system which is image-space telecentric, a high-resolution image can be obtained in a wide field of view.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 Illustrates a general configuration for a first embodiment of an acousto-optic image capture device according to the present invention.

FIG. 2 is a ray diagram showing the function of an acoustic lens system 6 according to the first embodiment.

FIG. 3A illustrates a configuration for a light source 19 according to the first embodiment.

FIG. 3B illustrates a configuration for a uniform illumination optical system 31 according to the first embodiment.

FIG. 3C illustrates another configuration for the optical system 31.

FIG. 4A illustrates still another configuration for a uniform illumination optical system 31 according to the first embodiment.

FIG. 4B illustrates the arrangement of single-mode optical fibers in FIG. 4A.

FIG. 4C illustrates yet another configuration for a uniform illumination optical system 31 according to the first embodiment.

FIG. 4D illustrates yet another configuration for a uniform illumination optical system 31 according to the first embodiment.

FIG. 5 illustrates where a uniformly illuminated plane 43 may be set according to the first embodiment.

FIG. 6A schematically illustrates how a plane-wave light beam is subjected to Bragg diffraction by a plane acoustic wave in the first embodiment.

FIG. 6B schematically shows a Bragg diffraction condition on a one-dimensional diffraction grating.

FIG. 7A illustrates how the diffracted light 201 is distorted in the y direction in the first embodiment.

FIG. 7B illustrates the structure of an anamorphic prism for use as an image distortion correcting section 15 in the first embodiment.

FIG. 8 shows the optical path of a light beam in a wedge prism implementing an anamorphic prism.

FIG. 9 illustrates how plane-wave light beams with mutually different angles of incidence are subjected to Bragg diffraction in the first embodiment.

FIG. 10A illustrates conceptually how a double diffraction optical system works in the field of optics.

FIG. 10B shows how the acousto-optic image capture device of the first embodiment can be regarded as such a double diffraction optical system.

FIG. 11A illustrates a direction in which a plane-wave light beam 14 may be incident in the first embodiment.

FIG. 11B illustrates an alternative direction in which the plane-wave light beam 14 may be incident.

FIG. 12 illustrates the structure of a cylindrical lens.

FIG. 13 illustrates an optical system according to the first embodiment, which is implemented as a combination of two cylindrical lenses and which functions as both an image distortion correcting section 15 and as an imaging lens system 16.

FIG. 14 illustrates a general configuration for a second embodiment of an acousto-optic image capture device according to the present invention.

FIG. 15 schematically illustrates a specific example of the second embodiment.

FIG. 16 illustrates a configuration for an acoustic lens system 6 according to a third embodiment.

FIG. 17 illustrates a configuration for an image distortion correcting section 15 according to a fourth embodiment.

FIG. 18 illustrates a configuration for an image distortion correcting section 15 according to a fifth embodiment.

FIG. 19 illustrates a general configuration for a sixth embodiment of an acousto-optic image capture device according to the present invention.

FIG. 20 schematically illustrates a configuration for an acoustic lens system in an acousto-optic image capture device as a seventh embodiment of the present invention.

FIG. 21A schematically illustrates a plane wave created by an acoustic lens system according to the seventh embodiment.

FIG. 21B schematically illustrates a plane wave created by an acoustic lens system which is not telecentric.

FIG. 22 schematically illustrates a specific exemplary configuration for an acoustic lens system according to the seventh embodiment.

FIG. 23 schematically illustrates an alternative configuration for an acoustic lens system in an acousto-optic image capture device according to the seventh embodiment of the present invention.

FIG. 24 schematically illustrates another specific exemplary configuration for an acoustic lens system according to the seventh embodiment.

FIG. 25A illustrates the structure of an exemplary subject.

FIG. 25B illustrates an image to be obtained when the subject shown in FIG. 25A is a shot using an acoustic lens system which is double telecentric or object-space telecentric.

FIG. 25C illustrates an image to be obtained when the subject shown in FIG. 25A is a shot using an acoustic lens system which is not double telecentric or object-space telecentrc.

FIG. 26 schematically illustrates a configuration for a device disclosed in Non-Patent Document No. 1.

### DETAILED DESCRIPTION

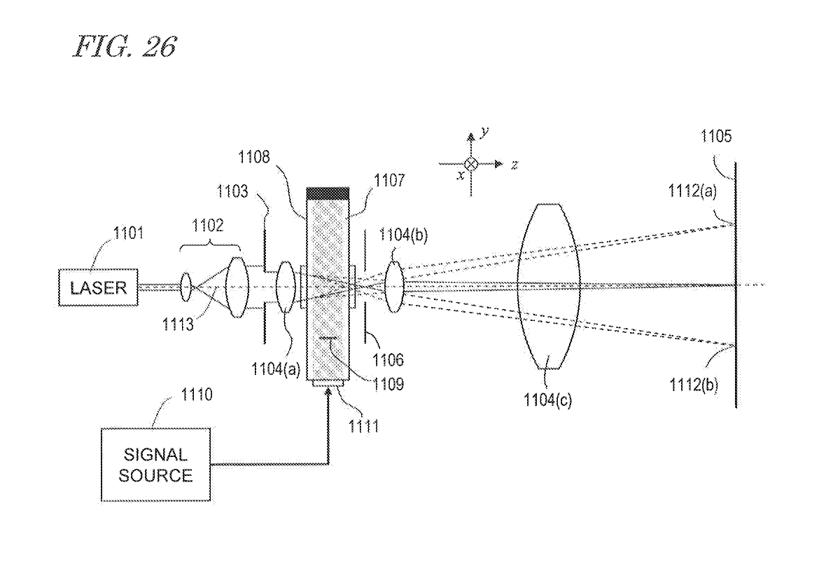

The present inventors carried out an intensive research to find out why high imaging properties could not be achieved by only adopting the technique disclosed in Non-Patent Document No. 1. As shown in FIG. 26, according to the configuration disclosed in Non-Patent Document No. 1, the real images of the subject 1109 are ±first-order diffracted images 1112(a) and 1112(b), and therefore, are formed outside of the optical axis of the optical system. Generally speaking, the more distant from the optical axis an imaging optical system (i.e., an optical system which produces real images) is, the greater its off-axis aberrations will be, and the more difficult it will be to produce real images of good image quality. That is why according to the configuration shown in FIG. 26, the images would be deteriorated due to the off-axis aberrations.

Also, according to the Bragg diffraction, if a normal to the lattice plane is defined, the traveling directions of the incident light and diffracted light are determined uniquely. According to the configuration shown in FIG. 26, at an arbitrary point in a region of the water 1107 through which a monochromatic ray of light passes, there is only one ray of light that travels in a fixed direction. That is why in some cases, diffracted ray of lights will not be produced for every ultrasonic scattered wave created from the subject 1109. According to the wave optics, it is not until every scattered wave coming to the aperture of a lens contributes to forming an image that a real image, of which the resolution is determined by the aberration of the lens, is generated. For that reason, the resolution of the real image generated by the optical system shown in FIG. 26 would be inferior to the resolution to be determined by the wave optics.

In addition, the technique disclosed in Non-Patent Document No. 1 has another problem. Specifically, according to the technique disclosed in Non-Patent Document No. 1, the size of the configuration increases. In Non-Patent Document No. 1, water 1107 is used as ultrasonic wave propagation medium. As ultrasonic waves have as high a propagation velocity as approximately 1500 m/s in water, even ultrasonic waves with as high a frequency as 22 MHz as disclosed in Non-Patent Document No. I will have a wavelength of approximately 68 μm. That is why if a light source with a wavelength of 633 nm as disclosed in Non-Patent Document No. 1 is used as the He—Ne laser 1101, the angle of diffraction of the ±first-order diffracted images 1112(a) and 1112(b) will be very small (e.g., about 0.27 degrees). Therefore, to equalize the horizontal and vertical image magnifications in FIG. 26, the ratio of the focal lengths of the two cylindrical lenses 1104(b) and 1104(c) should be increased and the screen 1105 and the acoustic cell 1108 should be spaced from each other by several meters.

Furthermore, according to the technique disclosed in Non-Patent Document No. 1, the subject 1109 needs to be dipped in a hermetically sealed container which is filled with the water 1107. On top of that, since the ultrasonic scattered wave for use in Bragg diffraction is a forward scattered wave with respect to the subject 1109, it is difficult to shoot the subject from the acoustic wave irradiation side.

Thus, to overcome such problems with the related art, the present inventors invented an acousto-optic image capture device with a novel configuration.

An aspect of the present invention can be outlined as follows.

An acousto-optic image capture device according to an aspect of the present disclosure includes: an acoustic wave source; an acoustic lens system configured to transform a scattered wave, created by irradiating a subject with an acoustic wave that has been emitted from the acoustic wave source, into a predetermined converged state; an acousto-optic medium portion arranged so that the scattered wave that has been transmitted through the acoustic lens system is incident on the acousto-optic medium portion; a light source configured to emit a light beam in which a plurality of monochromatic rays of light with mutually different traveling directions are superposed one upon the other and which is incident on the acousto-optic medium portion at an angle with respect to, and neither perpendicularly nor parallel to, the acoustic beam axis of the acoustic lens system; an imaging lens system configured to condense diffracted rays of light of the plurality of plane wave monochromatic rays of light that have been produced by the acousto-optic medium portion; and an image receiving section configured to detect the rays of light that have been condensed by the imaging lens system to output an electrical signal. The acoustic lens system includes at least a telecentric acoustic system that is image-space telecentric and a sound-collecting acoustic system that is arranged on the image space. The distance between the telecentric acoustic system and the sound-collecting acoustic system is equal to the sum of the respective focal lengths of the telecentric acoustic system and the sound-collecting acoustic system. And the light beam is transmitted at the focal point of the sound-collecting acoustic system through the acousto-optic medium portion.

The telecentric acoustic system includes at least one sound-collecting lens, and a diaphragm which may be arranged on object side with respect to the sound-collecting lens.

The telecentric acoustic system may be double telecentric.

The telecentric acoustic system may include first and second sound-collecting lenses and a diaphragm that is arranged between the first and second sound-collecting lenses.

The acousto-optic image capture device may further include an image distortion correcting section configured to correct the distortion of the diffracted rays of light and/or the subject image represented by the electrical signal.

The monochromatic rays of light may have a spectrum width of less than 10 nm and are plane waves, of which the wavefront accuracy is ten times or less of the wavelength at the center frequency of the monochromatic rays of light.

The acoustic lens system may be made of a nanoporous silica or fluorinert.

The acoustic lens system may include a focal length adjusting mechanism.

The imaging lens system may include a focal length adjusting mechanism.

The light source may include a plurality of fly-eye lenses.

The image distortion correcting section may include an optical member that increases the cross-sectional area of the diffracted rays of light.

The image distortion correcting section may include an optical member which decreases the cross-sectional area of the diffracted rays of light.

The optical member may be implemented as an anamorphic prism.

At least one of the imaging lens system and the optical member may include at least one cylindrical lens.

The image distortion correcting section may perform image processing based on the electrical signal.

The acousto-optic medium portion may include at least one of a nanoporous silica nanopore, fluorinert and water.

The diffracted rays of light may include Bragg diffracted light components which account for a half or more by intensity ratio.

The optical axis of the light beam emitted from the light source may be adjustable with respect to the acoustic beam axis of the acoustic lens system and the acoustic wave is a pulsed one.

### Embodiment 1

Hereinafter, a first embodiment of an acousto-optic image capture device according to the present invention will be described with reference to the accompanying drawings.

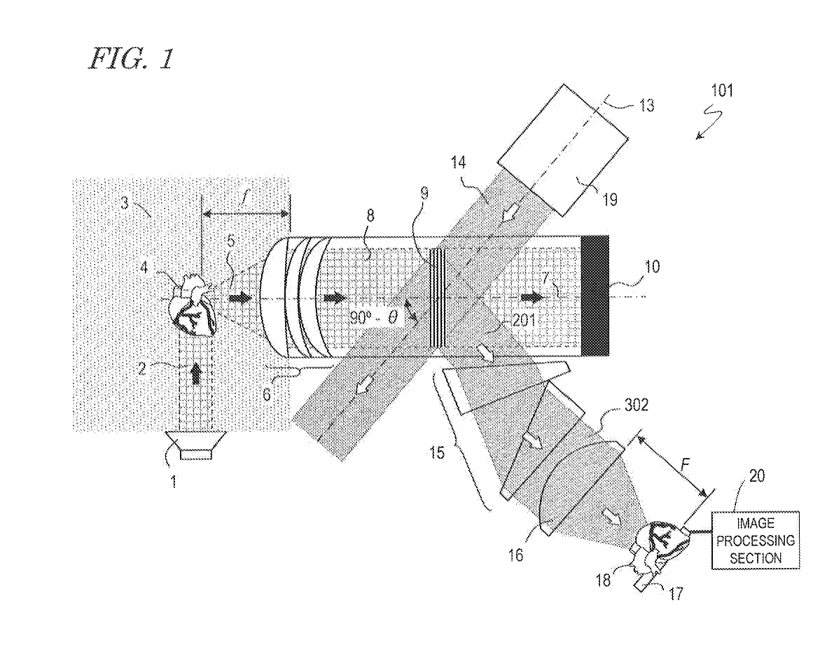

FIG. 1 schematically illustrates a configuration for an acousto-optic image capture device 101, which includes an acoustic wave source 1, an acoustic lens system 6, an acousto-optic medium portion 8, a light source 19, an image distortion correcting section 15, an imaging lens system 16, and an image receiving section 17.

A subject 4 is arranged in a medium 3 which can propagate an acoustic wave. Examples of such media 3 that can propagate acoustic waves include the air and water. Or the medium 3 may also be a body tissue or a metallic or concrete elastic body, for example.

The acoustic wave source 1 and the acoustic lens system 6 are arranged either in the medium 3 or in contact with the medium 3. By irradiating the subject 4 with an acoustic wave 2 that has been emitted from the acoustic wave source 1, the acoustic wave 2 is scattered from the surface of the subject 4 or its internal region with non-uniform acoustic impedances (which are quantities obtained by multiplying the speed of sound by the density) to generate a scattered wave 5. Then, the scattered wave 5 is transformed by the acoustic lens system 6 into a predetermined converged state (e.g., into a plane acoustic wave 9, in particular) and then enters the acousto-optic medium portion 8. By making the plane acoustic wave 9 propagate through the acousto-optic medium portion 8, ununiformity in refractive index distribution is formed in the acousto-optic medium portion 8. Meanwhile, a plane-wave light beam 14 emitted from the light source 19 enters the acousto-optic medium portion 8, and gets diffracted by the ununiform refractive index distribution in the acousto-optic medium portion 8. As a result, diffracted light goes out of the acousto-optic medium portion 8. By getting this diffracted light condensed onto the image receiving section 17 by the imaging lens system 16, a real image 18 of the subject 4 can be obtained. Hereinafter, the respective components of this acousto-optic image capture device 101 will be described in detail. More exactly, the real image 18 is an image which is produced on a plane that intersects with the acoustic beam axis 7 at right angles and that is away from the acoustic lens system 6 by the focal length f of the acoustic lens system 6 and which is similar to the two-dimensional distribution of elastic moduli of the subject 4.

1. Configuration of Acousto-Optic Image Capture Device 101

(1) Acoustic Wave Source 1

The acoustic wave source 1 emits an acoustic wave 2 toward the subject 4. The acoustic wave 2 is suitably an ultrasonic wave. If the subject 4 is going to be shot once, the acoustic wave 2 is suitably a pulse wave that is composed of multiple sin wave pulses, of which the amplitude and frequency are constant. The larger the number of the pulses, the higher the intensity of the diffracted light produced in the acousto-optic medium portion 8. Although not shown in FIG. 1, the time at which the acoustic wave source 1 gets the acoustic wave 2 generated by a trigger circuit is controlled precisely.

The acoustic wave 2 may or may not be a plane wave. The acoustic wave 2 suitably irradiates either the subject 4 in its entirety or only a region of the subject 4 to be shot at approximately a uniform intensity. That is to say, the acoustic wave 2 to irradiate suitably has a cross section, of which the size corresponds to the area of the region to be shot. The acoustic wave 2 is reflected and scattered from the surface and inside of the subject 4, thereby generating a scattered wave 5 having the same frequency as the acoustic wave 2.

(2) Acoustic Lens System 6

The acoustic lens system 6 converges the scattered wave 5 into a predetermined state. Specifically, the acoustic lens system 6 has a focal length f in the medium 3. The acoustic lens system 6 may be either a refracting acoustic system or a reflecting acoustic system. If the acoustic lens system 6 is a refracting acoustic system, the acoustic lens system 6 includes an acoustic lens which has at least one refracting interface and in which the scattered wave 5 is transmitted. The acoustic lens is suitably made of a nanoporous silica, fluorinert or any other elastic body which will cause a little acoustic wave transmission loss. The acoustic wave will be refracted by the refracting surface according to the Snell's laws of refraction. That is to say, the scattered wave 5 will be refracted at an angle which is determined by the ratio of the sonic velocities of the waves 5 scattered from the materials of the medium 3 and the acoustic lens. On the other hand, if the acoustic lens system 6 is a reflecting acoustic system, then the acoustic lens system 6 will have at least one reflecting interface which is made of a metal, glass or any other material, of which the acoustic impedance is significantly different from that of the medium 3. These refracting and reflecting interfaces have the same shape as an optical lens, and therefore, can converge the scattered wave 5.

Optionally, an antireflection film having the same function as an antireflection film to be stacked in the field of optics in order to reduce reflection, attenuation and stray light to be produced at a lens refracting surface may be provided for the refracting surface. For example, an antireflection film, of which the acoustic impedance is equal to the geometric mean of the acoustic impedances of the medium 3 and the acoustic lens and of which the thickness is a quarter wavelength (where the wavelength refers to the wavelength at the frequency of a sinusoidal wave that forms the acoustic wave 2), may be provided for the refracting surface.

The subject 4 is suitably located in the vicinity of the focal point of the acoustic lens system 6. As in an optical image capture device such as an optical camera, the more distant from the focal plane 21 of the acoustic lens system 6, the more blurred the real image 18 of the subject 4 gets. In this description, the focal plane 21 refers herein to a plane which intersects with the acoustic beam axis 7 at right angles and which is located closer to the subject 4 than the acoustic lens system 6 is by the focal length f of the acoustic lens system 6.

That is why to obtain a sharp real image 18 of the subject 4 that is located outside of the focal plane 21, the entire acousto-optic image capture device 101 is suitably moved so that the subject 4 is located right on the focal plane 21 of the acoustic lens system 6. If it is difficult to move the acousto-optic image capture device 101 along the acoustic beam axis 7 of the acoustic lens system 6, then the acoustic lens system 6 may further include a focus adjusting mechanism just like an image capturing lens for an optical camera. Furthermore, if the size of the real image 18 needs to be adjustable with respect to the subject 4, a focal length adjusting function (i.e., a zoom function) may be provided for one or both of the acoustic lens system 6 and the imaging lens system 16.

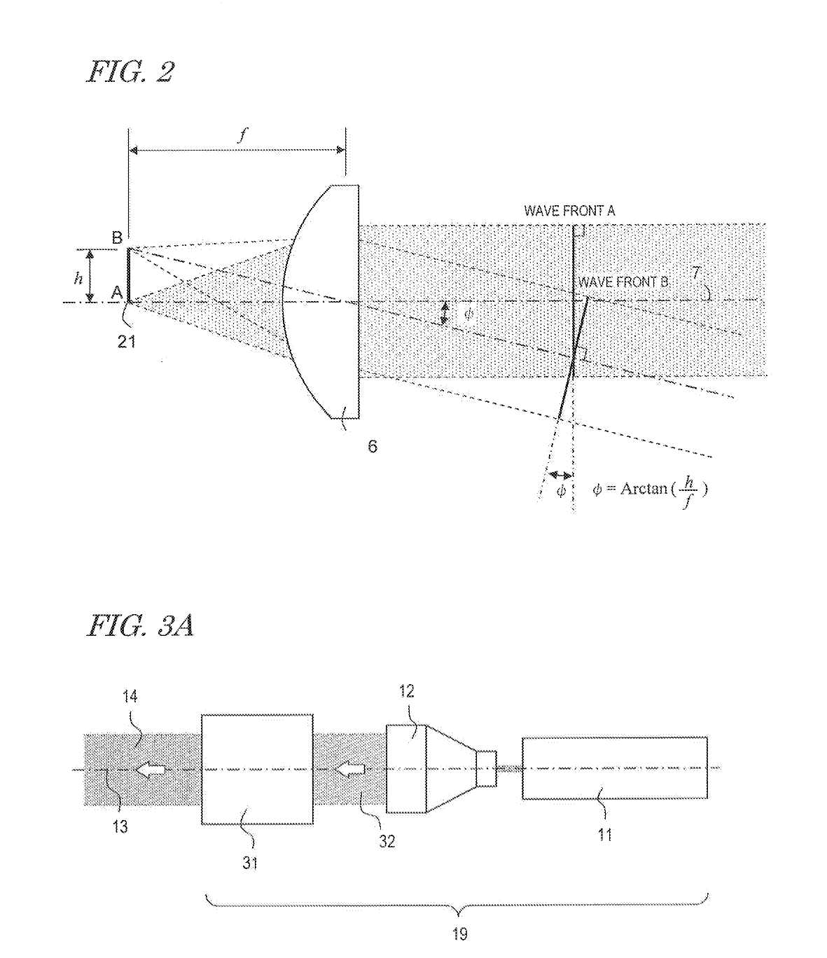

To simplify the discussion, the subject 4 is supposed to be located in the vicinity of the focal point f of the acoustic lens system 6 and the scattered wave 5 is supposed to be created on the focal plane 21 of the acoustic lens system 6. Since the scattered wave 5 is a spherical wave which is centered around an arbitrary point on the focal plane, the spherical wave is transformed by the acoustic lens system 6 into an acoustic wave to propagate through the acousto-optic medium portion 8 with a plane wavefront. As the spherical wave is transformed into such a plane acoustic wave from each point on the focal plane 21, the scattered wave 5 will be a plane acoustic wave 9 in which a plurality of plane acoustic waves with various traveling directions are superposed one upon the other when passed through the acoustic lens system 6. Suppose spherical waves are created from points A and B on the focal plane 21 as shown in FIG. 2. The point A is an intersection between the acoustic beam axis 7 and the focal plane 21. On the other hand, the point B is also on the focal plane 21 but located at a distance h from the acoustic beam axis 7. A spherical wave created at the point A is transformed into a plane wave with a plane wavefront A. Since the point A is located on the acoustic beam axis 7, a normal to the wavefront A becomes parallel to the acoustic beam axis 7. On the other hand, a spherical wave created at the point B is also transformed into a plane wave with a plane wavefront B. However, a normal to the wavefront B defines an angle φ with respect to the acoustic beam axis 7. As shown in FIG. 2, the angle φ is equal to Arctan (h/f), where Arctan indicates an arctangent function. Actually, however, a spherical wave is also created from every point between the points A and B. Consequently, the plane acoustic wave 9 shown in FIG. 1 becomes an acoustic wave in which a plurality of plane waves, where normals to their wavefront define various angles ψ with respect to the acoustic beam axis 7, are superposed one upon the other.

(3) Acousto-Optic Medium Portion 8

The acousto-optic medium portion 8 is made of an isotropic elastic body which causes little propagation attenuation with respect to the acoustic wave 2 with a sinusoidal wave frequency (i.e., the scattered wave) and which transmits the light beam 14 to be described later. Examples of suitable elastic bodies like that include a silica dry gel with nanopores, fluorinert and water. To improve the image quality (particularly, the resolution) of the real image 18, a light transmitting elastic body with as low sound speed as possible is suitably used. More suitably, a nanoporous silica or fluorinert is used.

The acousto-optic medium portion 8 is suitably arranged with respect to the acoustic lens system 6 so that the plane acoustic wave 9 transformed by the acoustic lens system 6 enters the acousto-optic medium portion 8 at a low loss. And the acoustic lens system 6 is suitably joined with the acousto-optic medium portion 8. Also, to suppress attenuation that would be caused on the junction due to reflection, the junction is suitably coated with art antireflection film. If the acoustic lens system 6 and the acousto-optic medium portion 8 are made of the same material, then the acoustic lens system 6 may be provided for a part of the acousto-optic medium portion 8 (which is suitably the boundary with the medium 3). As shown in FIG. 1, the plane acoustic wave 9 which travels parallel to the acoustic beam axis 7 propagates through a region of the acousto-optic medium portion 8 covering the acoustic beam axis 7 so that its wavefront intersects with the acoustic beam axis 7 of the acoustic lens system 6 at right angles. That is why the acousto-optic medium portion 8 includes the acoustic beam axis 7 of the acoustic lens system 6.

(4) Acoustic Wave Absorbing Member 10

If the plane acoustic wave 9 that has propagated through the acousto-optic medium portion 8 is reflected from the end of the acousto-optic medium portion 8 and if the reflected plane acoustic wave 9 affects the detection of the plane acoustic wave 9, an acoustic wave absorbing member 10 is suitably provided at the end of the acousto-optic medium portion 8. The acoustic wave absorbing member 10 either absorbs or attenuates the plane acoustic wave 9 without reflecting or scattering it. Since the acoustic wave absorbing member 10 absorbs every acoustic wave that has ever reached the acoustic wave absorbing member 10, the plane acoustic wave 9 propagating in one direction will be the only acoustic wave that is present in the acousto-optic medium portion 8. As a result, it is possible to avoid a situation where the plane acoustic wave 9 reflected is detected as noise to debase the image quality of the subject 4.

(5) Light Source 19

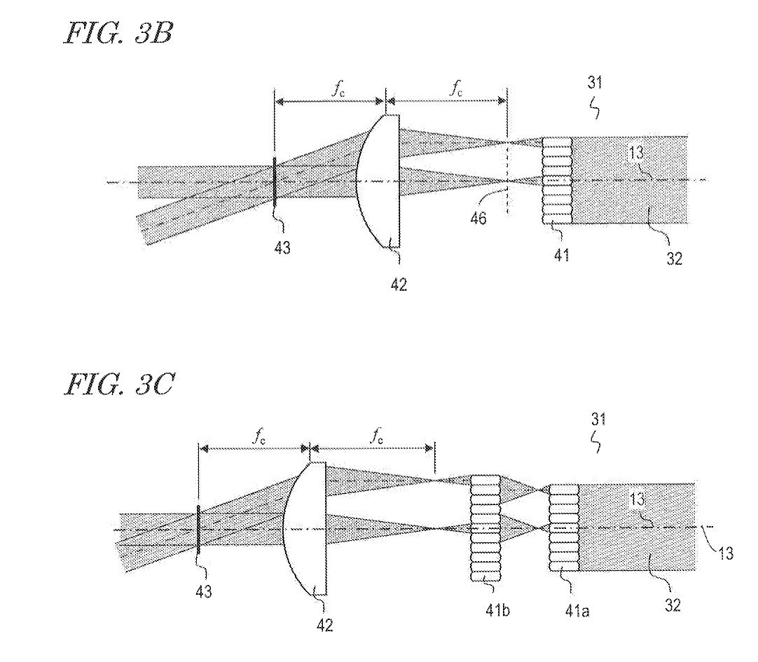

The light source 19 emits a plane-wave light beam 14 in which a plurality of monochromatic rays of light with mutually different traveling directions are superposed one upon the other. The light source 19 is arranged with respect to the acousto-optic medium portion 8 so that the light beam 14 is incident on the acousto-optic medium portion 8 at an angle with respect to, and neither perpendicularly nor parallel to, the acoustic beam axis 7 of the acoustic lens system 6. Those monochromatic rays of light that form the light beam 14 are a bundle of plane-wave rays with the same wavelength. Although those rays of light have mutually different traveling directions, their wavelengths and phases are identical with each other. As shown in FIG. 3A, the light source 19 may include a monochromatic ray light source 11, a beam expander 12 and a uniform illumination optical system 31, for example.

The monochromatic ray light source 11 produces a highly coherent light beam which is parallel to the optical axis 13. That is to say, the rays of light that form the light beam (i.e., the bundle of rays) have the same wavelength and the same phase. Specifically, the light beam emitted from the monochromatic ray light source 11 suitably has a spectrum width (a half width) of less than 10 nm.

As the monochromatic ray light source 11, a gas laser such as an He—Ne laser, a solid-state laser, or a semiconductor laser, of which the band width has been narrowed by an external resonator, may be used. The monochromatic ray light source 11 may emit a light beam either continuously or intermittently as pulses. The wavelength of the light beam emitted from the monochromatic ray light source 11 suitably falls within a wavelength range that will cause little transmission loss to the acousto-optic medium portion 8. For example, if a nanoporous silica is used as the acousto-optic medium portion 8, a laser diode having a wavelength of 600 nm or more is suitably used as the monochromatic ray light source 11.

The beam expander 12 increases the diameter of the light beam that has been emitted from the monochromatic ray light source 11 and outputs a plane-wave light beam 32, of which the diameter has been increased. Even though the beam expander 12 increases the diameter, the wavefront state of the light beam is maintained. That is why the light beam that has been transmitted through the beam expander 12 is also a plane wave.

FIG. 3B is a schematic representation illustrating a configuration for the uniform illumination optical system 31. The uniform illumination optical system 31 includes fly-eye lenses 41 and a condenser lens 42. The fly-eye lenses 41 are comprised of a plurality of single lenses that are arranged two-dimensionally. Each of those single lenses has an optical axis that is parallel to the optical axis 13 of the plane-wave light beam 32. Also, the focal point of every one of those single lenses is located on a focal plane 46 which is a plane that intersects with the optical axis 13 at right angles. Optionally, the respective single lenses may also have mutually different aperture shapes and aperture sizes. Also, the single lenses that form the fly-eye lenses 41 may have mutually different focal lengths. In that case, those lenses that form the fly-eye lenses 41 may be translated with respect to the optical axis 13 so that their focal points agree with the focal plane 46. The condenser lens 42 has a focal length fc, and is arranged at a distance fc from the focal plane 46. The optical axis of the condenser lens 42 agrees with the optical axis 13 of the plane-wave light beam 32.

When incident on the fly-eye lenses 41, the plane-wave light beam 32 is split and condensed spots are formed by the respective single lenses on the focal plane 46. If the fly-eye lenses 41 are comprised of n single lenses, then the total number of those spots is n. The n light beams that have converged on the focal plane 46 then travel toward the condenser lens 42 as spherical wave light beams which are centered around the spots on the focal plane 46. Since the focal plane 46 is also the focal plane of the condenser lens 42, those spherical wave light beams are transformed into plane-wave light beams by the condenser lens 42. However, as the spots formed on the focal plane 46 by single lenses other than those located on the optical axis 13 have shifted parallel from the optical axis 13, those plane-wave light beams produced by such single lenses other than those located on the optical axis 13 go out of the condenser lens 42 obliquely with respect to the optical axis 13 so as to cross the optical axis 13 on a plane which is located at a distance fc. That is to say, the plane-wave light beams produced by those single lenses travel toward the focal point of the condenser lens 42. That is why the n plane-wave light beams, which are as many as the single lenses, are incident at various angles on, and converge toward, the focal point. In the following description, a plane that includes this focal point and that intersects with the optical axis 13 at right angles will be referred to herein as a “uniformly illuminated plane 43”. Those n plane-wave light beams to be superposed one upon the other on the uniformly illuminated plane 43 suitably have wavefront accuracy which is ten times or less of the wavelength at the center frequency of the monochromatic rays of light emitted from the monochromatic ray light source 11.

if the uniformly illuminated plane 43 is illuminated with a plurality of plane-wave light beams at multiple different angles, then it means that at an arbitrary point on the uniformly illuminated plane 43, a lot of rays of light have been incident at various different angles. To make the acousto-optic image capture device 101 shoot the subject 4 in a wide range and at a high resolution, it is important to use such a light beam in which a plurality of monochromatic ray of lights with mutually different traveling directions have been superposed one upon the other. The reason will be described in detail later when it is described how this acousto-optic image capture device 101 operates.

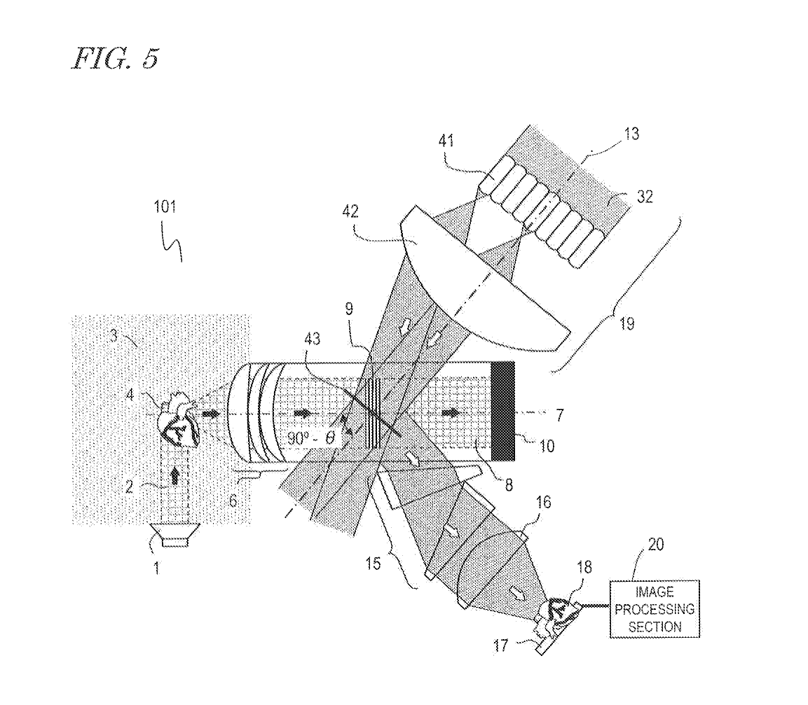

As shown in FIG. 5, in the acousto-optic medium portion 8 of the acousto-optic image capture device 101, the uniformly illuminated plane 43 suitably irradiates the entire plane acoustic waves 9 that are propagating through the acousto-optic medium portion 8. As a result, the plane-wave light beams can be incident at various angle of incidence onto either the plane acoustic waves 9 propagating through the acousto-optic medium portion 8 or the entire region in which the distribution of refractive indices of the acousto-optic medium portion 8 is formed by the plane acoustic waves 9. Consequently, a real image 18 with high luminance and high image quality can be produced in the entire image capturing region on the subject 4. That is why the cross-sectional area of the plane-wave light beams 14 shown in FIG. 1 is suitably larger than that of the region in which the plane acoustic waves 9 propagate through the acousto-optic medium portion 8.

If the plane-wave light beams need to be superposed one upon the other at an even larger angle of incidence (where the “angle of incidence” refers herein to the angle defined by the traveling direction of the plane-wave light beam formed by each single lens with respect to the optical axis 13) on the uniformly illuminated plane 43, a condenser lens 42 with an even smaller F number (which is obtained by dividing the focal length by the diameter of the lens aperture) is suitably used. If an image of the subject 4 needs to be captured in an even broader range, plane acoustic waves which are further tilted with respect to the acoustic beam axis 7 are created as shown in FIG. 2. In order to produce Bragg diffracted light based on such plane acoustic waves, plane-wave light beams with an even larger angle of incidence need to be used. That is why by using a condenser lens 42 with a smaller F number, an image of the subject 4 can be captured in a wide range.

Also, if an even larger number of plane waves with mutually different angles of incidence need to be superposed one upon the other on the uniformly illuminated plane 43, the fly-eye lenses may be arranged in multiple stages as shown in FIG. 3C. Specifically, as shown in FIG. 3C, the plane-wave light beam 32 emitted from a monochromatic ray light source may be incident on the condenser lens 42 through two sets of fly-eye lenses 41a and 41b. In the optical system illustrated in FIG. 3C, a light beam formed by one single lens of the fly-eye lenses 41a is split by the fly-eye lenses 41b into three light beams. As a result, three times as large a number of plane-wave light beams as the number of small lenses that form the fly-eye lenses 41 are incident on the uniformly illuminated plane 43 at mutually different angles.

The uniform illumination optical system 31 functions as not only an optical system to produce groups of light beams with different angles of incidence but also an optical system which produces a light beam with a uniform illumination distribution. The light intensity distribution on a light beam cross section of the plane-wave light beam 32 produced by the optical system shown in FIG. 3A is roughly a Gaussian distribution which is rotationally symmetric around the optical axis 13. However, due to the function of the uniform illumination optical system 31, the light intensity distribution becomes substantially uniform on the uniformly illuminated plane 43.

On the uniformly illuminated plane 43, the light beams that have been incident on and transmitted through the respective single lenses that form the fly-eye lenses 41 are projected after having been magnified. Suppose single lenses with sufficiently small apertures are used to form the fly-eye lenses. In that case, even if the plane-wave light beams 32 have a light intensity distribution, the light beams incident on the respective single lenses have a substantially uniform light intensity distribution because the respective single lenses have small apertures. Since such light beams are magnified and superposed one upon the other on the uniformly illuminated plane 43, the light intensity distribution becomes substantially uniform there. It should be noted that the smaller the aperture of the respective single lenses compared to the light beam diameter of the plane-wave light beams 32 and the larger the number of stages of the fly-eye lenses, the flatter the illumination distribution on the uniformly illuminated plane 43. To produce a real image 18 with no unevenness in illuminance, it is effective to flatten the illuminance distribution.

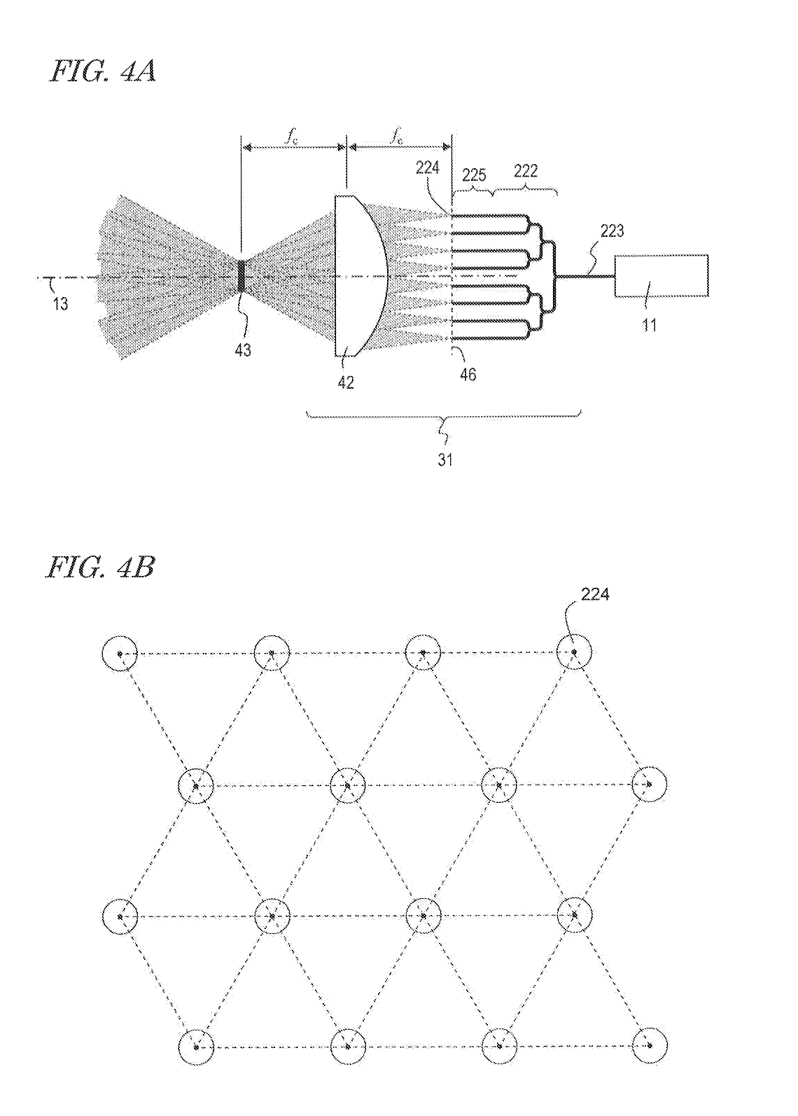

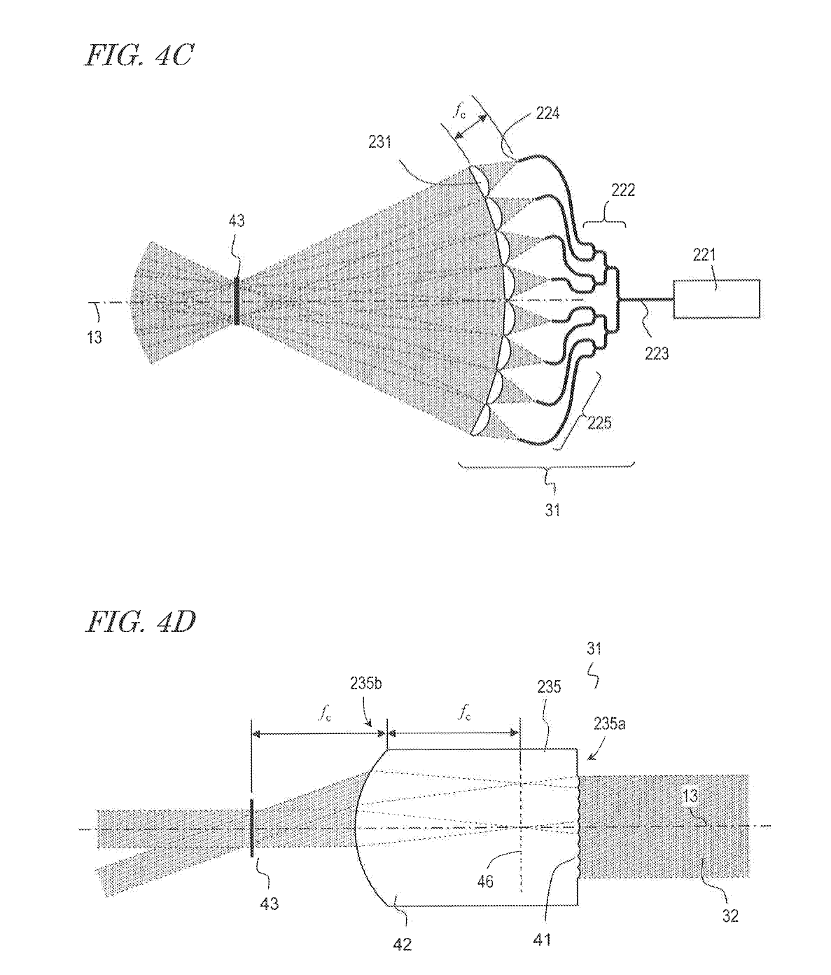

The uniform illumination optical system 31 may also have a different configuration. For example, the uniform illumination optical system 31 shown in FIG. 4A includes a single-mode optical fiber 223, a plurality of single-mode optical fibers 225, an optical fiber coupler array 222 which optically couples the single-mode optical fiber 223 and the plurality of single-mode optical fibers 225 together, and a condenser lens 42. A highly coherent plane-wave light beam that has been emitted from a monochromatic ray light source 11 such as a semiconductor laser is guided to the single-mode optical fiber 223. The optical fiber coupler array 222 is optically connected to one end of the single-mode optical fiber 223. The plane-wave light beam that has been incident on the single-mode optical fiber 223 then enters each of the optical fiber couplers in the array 222 connected to the single-mode optical fiber 223, and is split into plane-wave light beams to propagate through the single-mode optical fibers 225. In this case, the quantities of light propagating through the plurality of single-mode optical fibers 225 are approximately equal to each other. Such an even distribution of light quantities can get done by using a three-branch optical fiber coupler (i.e., a 3 dB optical fiber coupler) to make an even distribution of light quantities as the optical fiber coupler array 222. Alternatively, a single-to-multiple branching optical fiber coupler or optical, waveguide which evenly distributes the light quantities may be used. If the plane-wave light beam is split by an optical waveguide, a line converter is suitably inserted between the single-mode optical fiber and the optical waveguide. For example, it is recommended that a fine adjustment mechanism for adjusting the position of either the optical waveguide or the optical fiber be used so that the respective end faces of the optical waveguide and the optical fiber are brought close to each other at less than one wavelength and that the optical axis of the optical waveguide agrees with the optical axis of the optical fiber. Still alternatively, a prism may also be used as the line converter.

The respective end faces 224 of the single-mode optical fibers 225 are arranged two-dimensionally on the focal plane 46 of the condenser lens 42. FIG. 4B illustrates an arrangement of the end faces 224 on the focal plane 46. As shown in FIG. 4B, the end faces 224 may be arranged to form a triangular lattice, for example. The lattice spacing of this triangular lattice is selected so that the real images 18 to be produced on the image receiving section 17 by the light beams going out of the end faces 224 of the respective optical fibers are superposed one upon the other so as to have an appropriate overlap between them. The end faces 224 do not have to have a triangular lattice shape but may also have a tetragonal lattice shape as well.

The orientations of the respective single-mode optical fibers 225 are adjusted so that the respective center axes of the light beams going out of the end faces of the optical fibers 224 become parallel to the optical axis 13. As already described with reference to FIG. 4A, the respective light beams that have been transmitted through the condenser lens 42 converge toward a point on the uniformly illuminated plane 43 which is located at the focal length and where the optical axis 13 intersects with the uniformly illuminated plane 43. Consequently, a state where a lot of rays of light are incident at mutually different angles on an arbitrary point on the uniformly illuminated plane 43 is realized.

The uniform illumination optical system 31 shown in FIG. 4C includes a single-mode optical fiber 223, a plurality of single-mode optical fibers 225, an optical fiber coupler array 222 which optically couples the single-mode optical fiber 223 and the plurality of single-mode optical fibers 225 together, and a condenser lens array 231.

The single-mode optical fiber 223, the plurality of single-mode optical fibers 225, and the optical fiber coupler array 222 have the same configurations as their counterparts shown in FIG. 4A.

The condenser lens array 231 has a focal length fc′ and is comprised of a plurality of micro condenser lenses which are arranged two-dimensionally. Each of these micro condenser lenses is located at the focal length fc′ from the end face 224 of its associated single-mode optical fiber 225. Thus, the light beam that has gone out of each single-mode optical fiber 225 is transformed by its associated micro condenser lens into a parallel light beam. Also, by arranging these micro condenser lenses, the light beams that have gone out of the micro condenser lenses converge toward a point on the uniformly illuminated plane 43 at which the optical axis 13 intersects with the uniformly illuminated plane 43. Consequently, a state where a lot of rays of light are incident at mutually different angles on an arbitrary point on the uniformly illuminated plane 43 is realized.

The uniform illumination optical system 31 shown in FIG. 4D includes an optical element 235 which has the functions of the condenser lens and fly-eye lenses described above. This optical element 235 has two optical surfaces 235a and 235b. Specifically, the optical surface 235a is implemented as a fly-eye lens face which is comprised of a plurality of (or n) single-lens faces. On the other hand, the optical surface 235b is implemented as a condenser lens face. The condenser lens face has a focal length fc and this optical element 235 is designed so that the focal point of the condenser lens face is located right on the focal plane 46 where the respective focal points of the single-lens faces of the fly-eye lens face are located.

The uniform illumination optical system 31 shown in FIG. 4D functions in the same way as the uniform illumination optical system 31 shown in FIG. 4. Thus, as already described with reference to FIG. 4, the light beams that have gone out of the condenser lens face 235b converge toward a point on the uniformly illuminated plane 43 which is located at the focal length and at which the optical axis 13 intersects with the uniformly illuminated plane 43. Consequently, a state where a lot of rays of light are incident at mutually different angles on an arbitrary point on the uniformly illuminated plane 43 is realized. The uniform illumination optical system 31 according to the embodiment shown in FIG. 4D can be implemented as a single optical element, which is advantageous. Even though the shape of the optical element 235 is more complex than a single lens, such an optical element 235 can be made by a press forming process using low-melting glass, for example.

2. Operation of Acousto-Optic Image Capture Device 101

Next, it will be described how this acousto-optic image capture device 101 operates.

As shown in FIG. 1, an acoustic wave 2 with the waveform described above is sent out from the acoustic wave source 1 toward the subject 4, and either reflected or scattered from the subject 4, thereby creating a scattered wave 5. The scattered wave 5 thus created is transformed by the acoustic lens system 6 into a plane acoustic wave 9, which propagates through the acousto-optic medium portion 8.

As described above, the plane-wave light beam 14 is comprised of a lot of plane-wave light beams with mutually different traveling directions, and the plane acoustic wave 9 is also comprised of a lot of plane acoustic waves with mutually different traveling directions. However, in the following description, it will be described how the acousto-optic image capture device 101 operates on the supposition that the plane-wave light beam 14 consists of only a single plane-wave light beam, of which the wavefront intersects at right angles with the optical axis 13, and that the plane acoustic wave 9 consists of only a single plane acoustic wave which intersects at right angles with the acoustic beam axis 7.

The plane-wave light beam 14 is incident obliquely with respect to the acoustic beam axis 7 of the acoustic lens system 6. The optical axis 13 of the plane-wave light beam 14 defines an angle θ with respect to the wavefront of the plane-wave light beam 14. That is to say, the angle of incidence of the plane-wave light beam 14 on the wavefront of the plane acoustic wave 9 is θ. And the angle formed between the acoustic beam axis 7 and the optical axis 13 of the light beam 14 emitted from the light source 19 is calculated by 90 degrees minus θ. The angle θ may be any arbitrary angle other than 0, 90, 180 and 270 degrees. At this angle θ, Bragg diffraction is caused in the plane-wave light beam 14, thus producing diffracted light 201. That angle θ at which the diffracted light 201 is produced will be described later.

As described above, in this acousto-optic image capture device 101, the time of emission of the acoustic wave 2 is controlled so precisely that the plane acoustic wave 9 will have reached the intersection between the optical axis 13 and the acoustic beam axis 7 exactly by the time to shoot for the image receiving section 17. Specifically, if the interval of emission of the acoustic wave 2 is controlled at a time precision of 1 ns, the plane acoustic wave 9 propagating through the acousto-optic medium portion 8 at a speed of sound of 50 m/s will have a positional error of 50 nm. If a He—Ne laser is used as the monochromatic ray light source 11, this positional error corresponds to 0.079 wavelength when converted into 633 nm which is the wavelength of the He—Ne laser. That is why by adjusting the time of emission of the acoustic wave 2, the position of the plane acoustic wave 9 in the acousto-optic medium portion 8 can be controlled highly precisely.

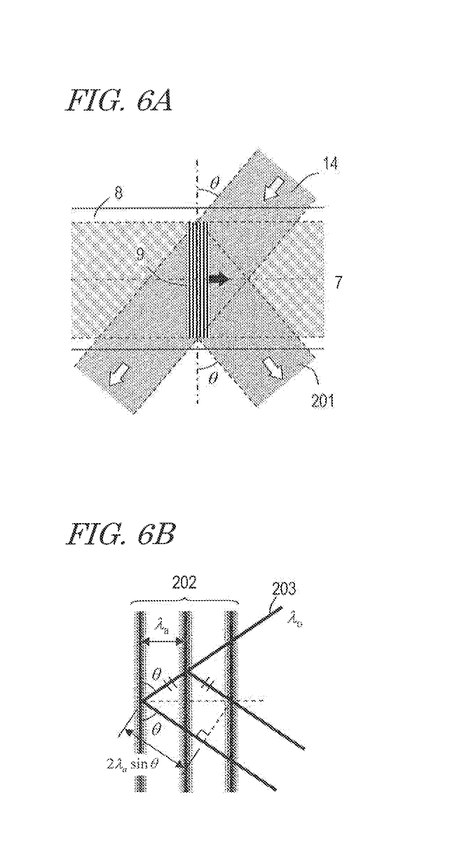

FIG. 6A schematically illustrates how the plane-wave light beam 14 is subjected to Bragg diffraction by the plane acoustic wave 9 at the moment when the plane acoustic wave 9 crosses the optical path of the plane-wave light beam 14. The plane acoustic wave 9 is a compressional elastic wave propagating through the acousto-optic medium portion 8. That is why a refractive index distribution which is proportional to the acoustic pressure distribution in the plane acoustic wave 9 is formed in the acousto-optic medium portion 8. Since the acoustic wave 2 is a sinusoidal wave with a single frequency as described above, the scattered wave 5 and the plane acoustic wave 9 are also sinusoidal waves with a single frequency. Consequently, the refractive index distribution formed in the acousto-optic medium portion 8 comes to have a periodic structure in which one period parallel to the acoustic beam axis 7 is equal to the wavelength of the plane acoustic wave 9 and in which the magnitude of the refractive index changes in a sinusoidal wave but is uniform perpendicularly to the acoustic beam axis 7.

Such a refractive index distribution functions as a one-dimensional diffraction grating with respect to the plane-wave light beam 14. That is why if the plane-wave light beam 14 is incident on the plane acoustic wave 9 at an angle θ that satisfies the diffraction condition to be described below, diffracted light 201 is produced. Since this one-dimensional diffraction grating has a planar lattice plane and since the wavefront of the plane-wave light beam 14 is also plane, the diffracted light 201 becomes a plane-wave light beam.

In this acousto-optic image capture device 101, the acoustic wave 2 is comprised of sinusoidal waves, of which the number of periods is far larger than two, and therefore, the dense and sparse ranges alternate twice or more in the refractive index distribution. That is why the refractive index distribution formed in the acousto-optic medium portion 8 can be regarded as a one-dimensional diffraction grating, and the plane-wave light beam 14 gets diffracted by Bragg diffraction. According to Bragg diffraction, the angles defined by the plane-wave light beam 14 and the diffracted light 201 with respect to the plane acoustic wave 9 are equal to each other and are both 8 as shown in FIG. 6A. The angle θ is a discrete value that satisfies the Bragg diffraction condition to be described later. If the acoustic wave 2 is comprised of a small number of sinusoidal waves, of which the number of periods is as small as two, the diffracted light 201 is produced mainly by Raman-Nath diffraction. A pure Raman-Nath diffraction will be produced even if the angles defined by the plane-wave light beam 204 and the diffracted light 201 with respect to the wavefront of the plane acoustic wave 9 are not equal to each other.

The Bragg diffraction will produce diffracted light 201 with a higher intensity than the Raman-Nath diffraction will. That is why according to Bragg diffraction, scattered wave 5 with a lower acoustic pressure can be observed, thus contributing to increasing the sensitivity. For that reason, in this acousto-optic image capture device 101, diffracted light 201 produced mainly by Bragg diffraction is suitably adopted using the acoustic wave 2 comprised of a large number of sinusoidal waves. In capturing an image actually, an acoustic wave 2 comprised of less than ten sinusoidal waves is used, and therefore, the diffracted light 201 includes Raman-Nath diffracted light. As will be described later, such an inclusion of the Raman-Nath diffracted light into the diffracted light 201 works fine to produce a good real image 18.

The Bragg diffraction condition to be imposed on a one-dimensional diffraction grating according to the refractive index distribution formed by the plane acoustic wave 9 will be described. As shown in FIG. 6B, the lattice spacing of the diffraction grating 202 formed by the plane acoustic wave 9 is equal to the wavelength λₐ of the plane acoustic wave 9 propagating through the acousto-optic medium portion 8. In the following description, one monochromatic ray of light in the plane-wave light beam 14 will be referred to herein as a “monochromatic ray 203”. The wavelength of the monochromatic ray 203 is supposed to be λ₀. If the monochromatic ray 203 is incident on the diffraction grating 202, weak scattered light is produced by each lattice. Looking at ray of lights scattered from adjacent lattice planes, if the difference in optical path length (2×λₐ×sin θ) between two ray of lights scattered toward the same direction from the respective lattice planes is equal to an integral multiple of the wavelength λ₀ (m×λ₀, m=±1, ±2, . . . ), then the two scattered ray of lights will enhance each other. Since such an enhancement will be caused on other lattice planes as well, scattered light with an overall high intensity (i.e., diffracted light) is produced. For these reasons, the angle θ at which the diffracted light is observed is represented by the following Equation (1):

$$θ = {sin}^{- 1} ( \frac{{λ}_{O} / {λ}_{a}}{2 \times m} ) , \\ ( m = \pm 1 , \pm 2 , … ) \qquad ( 1 )$$

This Equation (1) specifies the Bragg diffraction condition and defines the angle θ formed between incoming and outgoing rays of light with respect to a lattice plane. In Equation (1), sin⁻¹ indicates an arctangent function. A pure Bragg diffraction refers herein to a diffraction phenomenon to occur in a situation where the diffraction grating 202 is comprised of an infinite number of lattice planes. As shown in FIG. 6B, the angles defined by incoming and outgoing rays of light with respect to the lattice plane are equal to each other and are both θ. Generally speaking, according to the Bragg diffraction, the smaller the order m of diffracted light 201, the higher its intensity will be. For that reason, to observe a weaker scattered wave 5, diffracted light 201 which satisfies m=±1 is suitably used. Even though the diffracted light 201 satisfies m=±1 in the acousto-optic image capture device shown in FIG. 1, an acousto-optic image capture device that uses diffracted light, of which m=−1, may also be used.

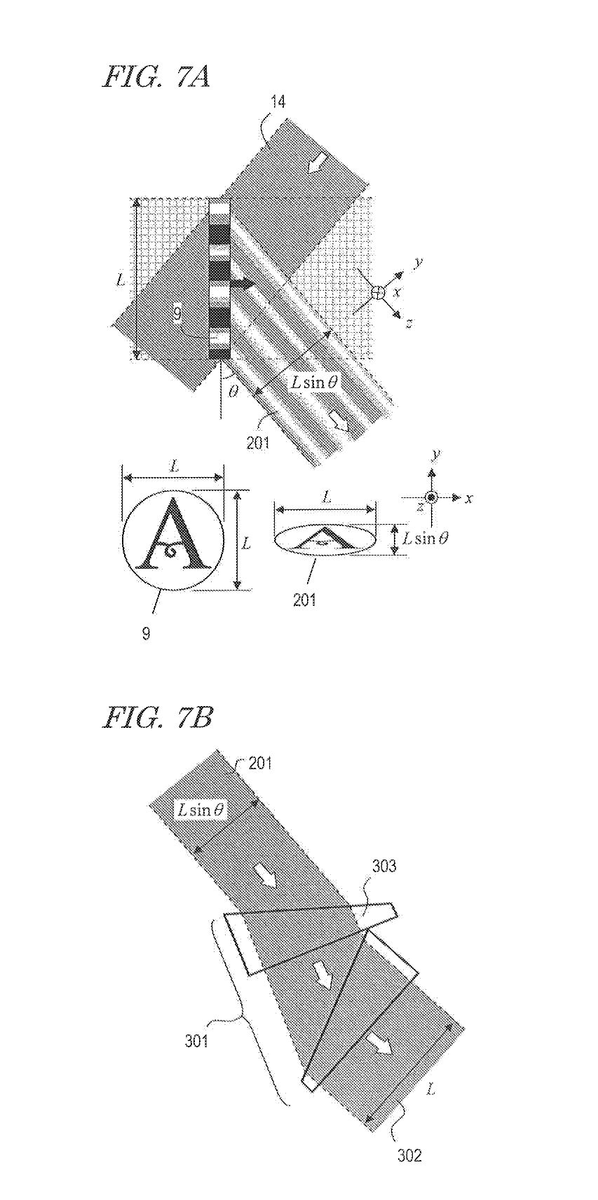

The diffracted light 201 enters an image distortion correcting section 15. Hereinafter, it will be described with reference to FIG. 7A how the image distortion correcting section 15 operates. FIG. 7A is a schematic representation showing how the diffracted light beam 201 converges in one direction in this acousto-optic image capture device 101. As can be seen from Equation (1), to satisfy the diffraction condition, the plane-wave light beam 14 needs to be incident obliquely with respect to the plane acoustic wave 9. In this case, the plane acoustic wave 9 is supposed to have a circular beam cross section with a diameter L and the angle of diffraction of the diffracted light 201 is supposed to be θ (which is just as defined in the foregoing description). As described above, the plane-wave light beam 14 has a beam diameter which is large enough to cover the plane acoustic wave 9 and the diffracted light 201 is produced only in a region where there is the plane acoustic wave 9. That is why the beam cross section of the diffracted light 201 becomes an elliptical one, of which the minor axis size is L×sin θ as measured in the y-axis direction and the major axis size is L as measured in the x-axis direction in the coordinate system shown in FIG. 7A. That is to say, the distribution of the amplitude of the light on the wavefront of the diffracted light 201 is proportional to the acoustic pressure distribution of the plane acoustic wave 9 on the wavefront multiplied by sin θ in the y-axis direction.

That is why if this diffracted light 201 were imaged as it is by the imaging lens system 16 to produce a real image 18, then the real image 18 would be an optical image distorted in the y-axis direction and the similarity between the subject 4 and the real image 18 would be lost. For that reason, the distortion of the diffracted light 201 needs to be corrected by the image distortion correcting section 15.

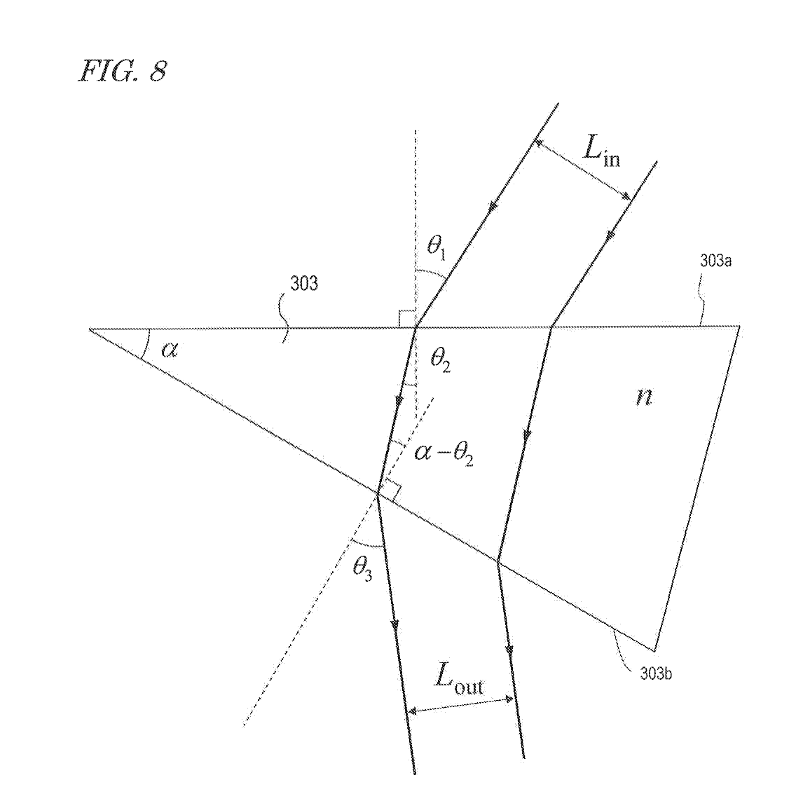

In this embodiment, the image distortion correcting section 15 is implemented as an anamorphic prism 301. FIG. 7B is a schematic representation illustrating the configuration and function of the anamorphic prism 301. As shown in FIG. 7B, the anamorphic prism 301 includes two wedge prisms 303. Hereinafter, it will be described with reference to FIG. 8 how these wedge prisms 303 work.

FIG. 8 is a ray diagram illustrating how rays of light are transmitted through the wedge prism 303. The wedge prism 303 is made of a material which is transparent to the diffracted light 201 with a refractive index n, and has two planes 303a and 303b. The angle formed between these two planes 303a and 303b is supposed to be α, the angle of incidence defined by the light beam incident on the plane 303a with respect to a normal to the plane 303a is supposed to be θ1, and the angle of emittance defined by the light beam going out of the plane 303a with respect to a normal to the plane 303a is supposed to be θ2. And the angle of emittance defined by the light beam going out of the plane 303b with respect to a normal to the plane 303b is supposed to be θ3. Also, in a plane including the normals to these two planes 303a and 303b, the width of the light beam incident on the plane 303a is supposed to be Lᵢₙ and the width of the light beam going out of the plane 303b is supposed to be Lₒᵤₜ. In this case, the relations represented by the following Equations (2) are satisfied:

sin θ₁=n×sin θ₂

n×sin(α−θ₂)=sin θ₃ (2)

Also, in the plane including the normals to the two planes 303a and 303b, the incoming light beam and the light beam going out of the wedge prism 303 have mutually different beam diameters. The light beam expansion ratio, calculated by Lₒᵤₜ/Lᵢₙ, is given by the following Equation (3):

$$\frac{{L}_{out}}{{L}_{i n}} = \sqrt{\frac{{n}^{2} + ( {n}^{2} - 1 ) {tan}^{2} {θ}_{1}}{{n}^{2} + ( {n}^{2} - 1 ) {tan}^{2} {θ}_{3}}} \qquad ( 3 )$$

As can be seen from these Equations (2) and (3), by selecting α, n and angle θ1 appropriately for the wedge prism 303, any light beam expansion ratio can be obtained just as intended. The light beam expansion ratio does not change perpendicularly to the plane including normals to the two planes 303a and 303b irrespective of α, n and angle θ1. That is why by using this wedge prism 303, the width of the diffracted light 201 shown in FIG. 7A can be adjusted in the y-axis direction.

As shown in FIG. 7B, the anamorphic prism 301 is obtained by combining more than one wedge prism 303 shown in FIG. 8. If two wedge prisms 303 of the same shape are used in combination as shown in FIG. 7B, the light incident on the anamorphic prism 301 and the light going out of the anamorphic prism 301 can be made parallel to each other, and the optical system can be adjusted easily.

As can be seen, the anamorphic prism 301 operates as an optical system that expands the diameter of the light beam. In the acousto-optic image capture device 101, α, n and the angle of incidence θ1 are selected for the wedge prism 303, and the diffracted light beam 201 is expanded by the factor of 1/sin θ in the y-axis direction as shown in FIG. 7B. In this manner, distortion-corrected diffracted light 302 with a circular beam cross section having a diameter L can be obtained. Consequently, the distort ion-corrected diffracted light 302 has, on its wavefront, a light amplitude distribution which is proportional to the acoustic pressure distribution on the wavefront of the plane acoustic wave 9. That is to say, even though the distortion-corrected diffracted light 302 has a different wavelength from the plane acoustic wave 9, the entire acoustic pressure distribution on the wavefront of the plane acoustic wave 9 is reproduced as a light amplitude distribution. That is why a real image 18 which is similar to the subject 4 can be produced.

As shown in FIG. 1, the distortion-corrected diffracted light 302 is condensed by an imaging lens system 16 with a focal length F. Since the distortion-corrected diffracted light 302 is a parallel light beam, the diffracted light 302 is condensed onto a plane which is located on the optical axis of the imaging lens system 16 at the distance F from the imaging lens system 16 and which intersects at right angles with the optical axis (i.e., onto a focal plane), thus producing a real image 18 there. By arranging the image receiving section 17 at that position, the real image 18 can be converted into an electrical signal.

Based on the electrical signal supplied from the image receiving section 17, the image processing section 20 performs image processing, thereby forming a real image 18. In this manner, the acousto-optic image capture device can shoot the subject 4.

In the foregoing description, the plane-wave light beam 14 is supposed to consist of only a plane-wave light beam, of which the wavefront intersects at right angles with the optical axis 13, and the plane acoustic wave 9 is supposed to consist of only a plane acoustic wave which intersects at right angles with the acoustic beam axis 7. However, since the subject 4 is not a point on the acoustic beam axis 7 but has a finite size as already described with reference to FIG. 2, the plane acoustic wave 9 that has been transformed by the acoustic lens system 6 includes a lot of plane acoustic waves which do not intersect at right angles with the acoustic beam axis 7. In the acousto-optic image capture device of this embodiment, as the plane-wave light beam 14 is formed by superposing a plurality of monochromatic rays of light with mutually different traveling directions one upon the other, even those plane acoustic waves 9 with different traveling directions can also produce Bragg diffracted light.

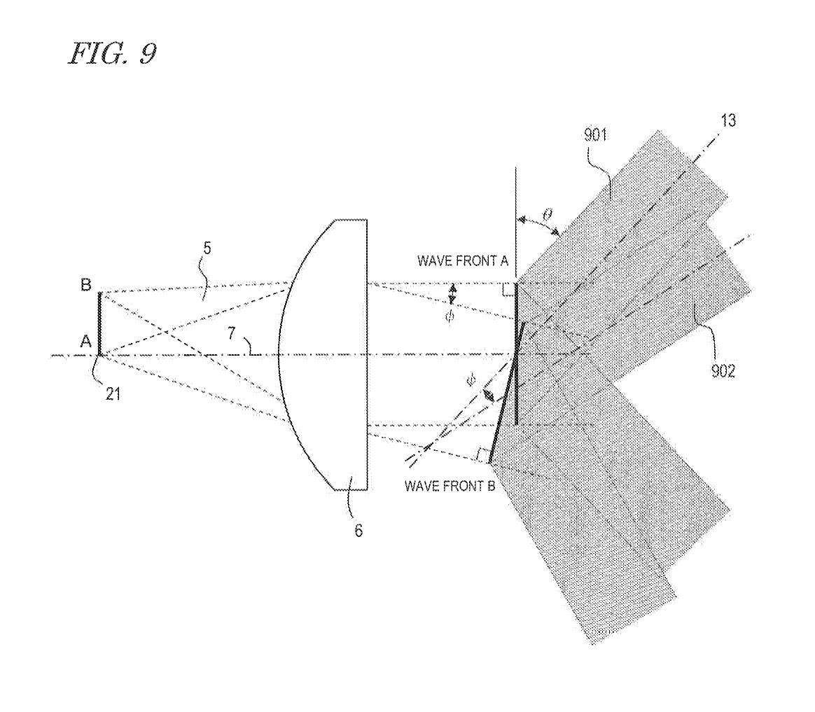

FIG. 9 shows how scattered waves 5 which have been created at two points A and B on the subject 4 and on the focal plane 21 of the acoustic lens system 6 are transformed into a plane acoustic wave 9 to produce Bragg diffracted light. Although the point A is located at the intersection between the acoustic beam axis 7 and the focal plane 21, the point B is not located on the acoustic beam axis 7. As already described with reference to FIG. 2, the wavefront A of the plane acoustic wave 9 based on the scattered wave 5 that has been created at the point A is a plane which intersects at right angles with the acoustic beam axis 7. However, the wavefront B of the plane acoustic wave 9 based on the scattered wave 5 that has been created at the point B, which is off the acoustic beam axis 7, is not a plane which intersects at right angles with the acoustic beam axis 7 but defines an angle ψ with respect to the acoustic beam axis 7. In this case, the angle ψ is just as defined above with reference to FIG. 2.

Now look at a plane-wave light beam 901 which is parallel to the optical axis 13 among a lot of plane-wave light beams that have been produced by the light source 19. The angle formed between the acoustic beam axis 7 and the optical axis 13 is adjusted so that the plane-wave light beam 901 is incident on the wavefront A at such an angle θ that satisfies the Bragg diffraction condition. That is why diffracted light is produced at the wavefront A. On the other hand, the angle of incidence of the plane-wave light beam 901 with respect to the wavefront B becomes θ−ψ, and therefore, the Bragg diffraction condition is not satisfied and no diffracted light is produced. Consequently, with only the plane-wave light beam 901 used, no diffracted light will be produced based on the scattered wave 9 that has been created at the point B and an optical image corresponding to the point B will be missing from the real image 18.

To produce diffracted light at the wavefront B, the wavefront B may be irradiated with a plane-wave light beam 902 which defines a tilt angle ψ clockwise with respect to the optical axis 13 as shown in FIG. 9. Since the plane-wave light beam 902 is incident on the wavefront B at an angle θ, diffracted light corresponding to the scattered wave 9 that has been created at the point B will be produced. In that case, an optical image corresponding to the point B will be included in the real image 18.

As can be seen, to make optical images corresponding to the points A and B appear as parts of the real image 18, both of the plane-wave light beams 901 and 902 are needed. Likewise, to make points other than the points A and B on the subject 4 appear in the real image 18 properly, Bragg diffracted light needs to be produced based on the plane acoustic wave 9, of which the wavefront does not intersect at right angles with the acoustic beam axis 7 of the scattered waves 5 that have been created at those points. For that purpose, the plane-wave light beam is suitably incident on the acousto-optic medium portion 8 at various angles other than θ with respect to the wavefront A that does not intersect at right angles with the acoustic beam axis 7. According to this embodiment, the light source 19 emits a light beam in which a plurality of monochromatic rays of light with mutually different traveling directions are superposed one upon the other, and therefore, satisfies such a condition. Consequently, the subject 4 that is located on the focal plane 21 can be shot.

On the focal plane 21, the actual subject 4 is comprised of an infinite number of points. That is why to shoot the subject 4 with high resolution, an infinite number of plane-wave light beams should be prepared. And if only a finite number of plane-wave light beams with discrete angles of incidence are used as is done in this embodiment, the real image 18 seems to be an optical image consisting of as many discrete points as the number of the plane-wave light beams. However, the plane acoustic wave 9 is a pulsed acoustic wave and is comprised of a finite number of wavefronts. That is why the number of lattice planes of the diffraction grating to be formed in the acousto-optic medium portion 8 becomes a finite one, too. As described above, the diffracted light produced by a diffraction grating with a finite number of lattice planes includes not only Bragg diffracted light but also Raman-Nath diffracted light. The diffraction condition of the Raman-Nath diffraction does not depend on the angle of incidence. For that reason, even if the subject is irradiated with only the plane-wave light beam 901, actually not only an optical image at the point A but also optical images in the vicinity of the point A will be generated as parts of the real image 18. Consequently, the real image 18 to generate is not a set of discrete points but actually becomes a continuous optical image which is similar to the subject 4.

Nevertheless, the Raman-Nath diffracted light has so low an intensity that if the Raman-Nath diffraction prevails in the diffracted light 201, the resultant real image 18 of the subject 4 will not be a sharp one. That is why the ratio of the intensity of the Bragg diffracted light in the diffracted light 201 is suitably a half or more. For that purpose, the plane acoustic wave 9 is suitably a pulsed acoustic wave, of which the number of wavefronts is equal to or greater than the wavefront number Nmin represented by the following Equation (4):

$${N}_{min} = 10 \times \frac{{n}_{ao} {λ}_{a}}{2 {πλ}_{o}} \qquad ( 4 )$$

In Equation (4), no indicates the refractive index of the acousto-optic medium portion 8, λₐ indicates the wavelength of the acoustic wave in the acousto-optic medium portion 8, and λ₀ indicates the wavelength of the light emitted from the monochromatic ray light source and measured in the acousto-optic medium portion 8.

For example, if a nano-foam with a speed of sound of 50 m/s is used as the acousto-optic medium portion 8 and if an ultrasonic wave with a frequency of 5 MHz is used, then Nₘᵢₙ=13 is satisfied, because the refractive index of the nano-foam is almost one. That is why in that case, if a pulsed ultrasonic wave, of which the number of wavefronts is thirteen or more, is used, then the Bragg diffracted light will be a major diffracted light component.

As already described with reference to FIGS. 7A, 7B and 8, the light beam expansion ratio of the anamorphic prism 301 depends on the angle of incidence of a ray of light on the anamorphic prism 301 (corresponding to the angle θ1 shown in FIG. 8). That is why the diffracted light to be produced by a plurality of monochromatic rays of light that are superposed one upon the other in the plane-wave light beam is incident at different angles of incidence onto the anamorphic prism 301. As a result, the light beam expansion ratio changes from one monochromatic ray of light to another. Consequently, even if the distortion of the subject image is corrected using the anamorphic prism 301, the real image 18 will still have distortion. Thus, to reduce this distortion, the acousto-optic image capture device of this embodiment includes an image processing section 20 as shown in FIG. 1. The image processing section 20 performs image processing on the image data which has been captured by the image receiving section 17, thereby correcting the residual distortion of the real image 18 and obtaining an image which is analogous to the subject 4. For example, a real image 18 may be obtained by using a sheet of graph paper as the subject 4 in advance and image processing may be carried out so that the real image 18 obtained represents the whole sheet of graph paper correctly.

However, if the F number of the acoustic lens system 6 is large (i.e., if the lens aperture is small and if the focal length is long) or if the image capturing area of the subject 4 is small, then there will be a little difference in the angle of incidence onto the anamorphic prism 301 between multiple diffracted rays of light with different angles in the diffracted light 201 and the light beam expansion ratio can be regarded as substantially constant. That is why in such a situation, the image processing section 20 does not have to correct the distortion of the real image 18.

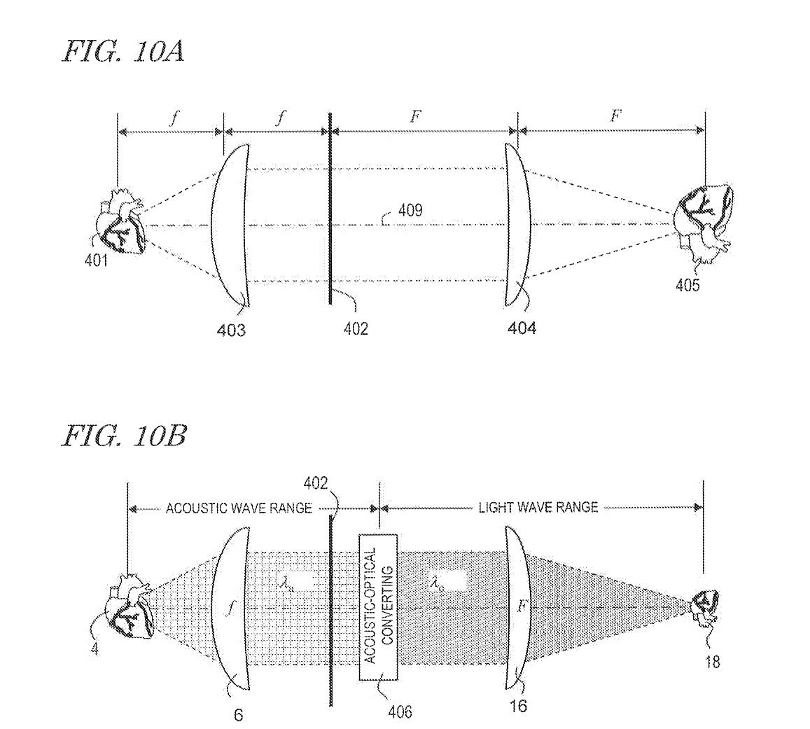

Next, it will be described what the relation in size between the subject 4 and the real image 18 may be in the acousto-optic image capture device of this embodiment. The acousto-optic image capture device of this embodiment may be regarded as a modified optical system of a double diffraction optical system including two optical lenses with focal lengths f and F numbers. FIG. 10A generally illustrates how a double diffraction optical system works in the field of optics.

In the double diffraction optical system shown in FIG. 10A, lenses 403 and 404 have focal lengths f and F, respectively. These two lenses are arranged on the optical axis 409 so as to be spaced apart from each other by a distance f+F. The optical axes of these two lenses agree with the optical axis 409. Generally speaking, a convex lens with a focal length fl has focal points at two points which are located on the optical axis and each of which is located at the distance fl from the center of the lens. According to the Fourier optics, an object put at one focal point of a convex lens and an optical image at the other focal point thereof satisfy a Fourier transform relation. That is why a Fourier transformed image of the subject 401 is produced by the lens 403 on a Fourier transform plane 402 which is the other focal plane (i.e., a plane which includes a focal point and which intersects at right angles with the optical axis). Since the Fourier transform plane 402 is also a focal plane of the lens 404, a Fourier transformed image of the subject 401 produced on the Fourier transform plane 402 is formed on the other focal plane of the lens 404. That is to say, the optical image produced on the other focal plane of the lens 404 corresponds to what is obtained by subjecting the subject 401 to a dual. Fourier transform. Since a dual Fourier transform is an affine mapping (i.e., a mapping technique which changes only the orientation of a figure by multiplying its size by a constant), a real image 405, which is a dual Fourier transformed image of the subject 401, becomes a figure which is similar to the subject 401. Also, the real image 405 appears as an inverted image of the subject 401 on the focal plane of the lens 404 and the lenses 403 and 404 have mutually different focal lengths. That is why the size of the real image 405 becomes F/f times as large as that of the subject 401. As can be seen, in the double diffraction optical system shown in FIG. 10A, an optical image which is analogous to the subject 401 appears as the real image 405, and therefore, if an image sensor such as a CCD is arranged at the focal plane of the lens 404 where the real image is produced, an image of the subject 401 can be captured.

The acousto-optic image capture device of this embodiment can be regarded as a double diffraction optical system, one of the two optical systems of which has been replaced with an acoustic system. As already described with reference to FIGS. 6A to 7B, the image distortion correcting section 15 which produces the diffracted light 201 in the acousto-optic image capture device of this embodiment may be regarded as a wavelength converting section 406 which converts (i.e., transfers) the amplitude distribution (acoustic pressure) on the wavefront of the plane acoustic wave 9 which is a plane wave with a wavelength λa into the amplitude distribution (light) of the distortion-corrected diffracted light 302 which is a plane wave with a wavelength λ0. That is why the acousto-optic image capture device of this embodiment is an optical-acoustic mixed optical system in which an optical system and an acoustic system coexist. Thus, by replacing the lenses 403 and 404 shown in FIG. 10A with an acoustic lens system 6 and an imaging lens system 16 as shown in FIG. 10B and by making the wavelength converting section 406 convert the wavelength λa into the wavelength λ0 (i.e., from an acoustic wave into a light wave) between these two lens systems, the acousto-optic image capture device of this embodiment operates in the same way as the double diffraction optical system shown in FIG. 10A. Consequently, according to the Fourier optics, even the optical-acoustic mixed optical system shown in FIG. 10B can also obtain an optical image which is similar to the subject 407 as an inverted real image on the focal plane of the imaging lens system 16 as in FIG. 10A.

However, before and after the wavelength converting section 406, the wavelength changes from λa into λ0. In the optical-acoustic mixed optical system shown in FIG. 10B, the size of the real image 18 becomes (F×λ0)/(f×λa) times as large as the subject 4. If λ0/λa is extremely small (i.e., if the wavelength of the acoustic wave in the acousto-optic medium portion 8 is far longer than the wavelength of the plane-wave light beam 14), a decrease in the resolution of the optical image obtained by the image receiving section 17 is suitably checked by preventing the real image 18 from becoming too small with (F×λ0)/(f×λa) increased by setting the F/f ratio to be high.

As can be seen, the acousto-optic image capture device of this embodiment gets a light beam in which a plurality of monochromatic rays of light with mutually different traveling directions are superposed one upon the other transmitted through an acousto-optic medium portion to propagate a scattered wave coming from the subject, thereby producing diffracted light based on a refractive index distribution that has been formed by a plane acoustic wave resultant from the scattered wave. When the scattered wave is transformed by an acoustic lens system into a plane acoustic wave to propagate through the acousto-optic medium portion, the scattered wave coming from the subject that is located away from the acoustic beam axis of the acoustic lens system travels non-parallel to the acoustic beam axis. However, as the multiple monochromatic rays of light that are superposed in the light beam have mutually different traveling directions, Bragg diffraction is also produced with respect to the refractive index distribution that has been formed in the acousto-optic medium portion by the scattered wave coming from such a position that is off the acoustic beam axis. As a result, even at such a position that is off the acoustic beam axis of the acoustic lens system, the subject can also be shot with low aberration and high resolution. That is to say, a high-resolution image with little off-axis aberration can be obtained.

In addition, in the acousto-optic image capture device of this embodiment, a double diffraction optical system is formed by the acoustic system and the optical system, and the distance between the acoustic system and the optical system can be shortened. As a result, the overall size of the acousto-optic image capture device can be reduced. Moreover, as there is no need to fill the subject with a liquid such as water, the subject can be shot from any arbitrary direction.

Even though the focal length of the acoustic lens system 6 is fixed in the acousto-optic image capture device 101 of the embodiment described above, the acoustic lens system 6 may also have a focusing mechanism (focal point adjusting mechanism) like an ordinary photographic lens' as described above. If the focal point of the acoustic lens system 6 is fixed, then a sharp real image 18 is obtained only when the subject is located in the vicinity of the focal point of the acoustic lens system 6 (more exactly, within the depth of field to be determined by the optical property of the acoustic lens system 6 and the pixel size of the image receiving section 17). That is why by providing a mechanism that can adjust the focal point of the acoustic lens system 6 for the acoustic lens system 6, the subject 4 can be captured in the optical axis direction. As can be seen, by providing such a focusing mechanism, a three-dimensional region can be shot.

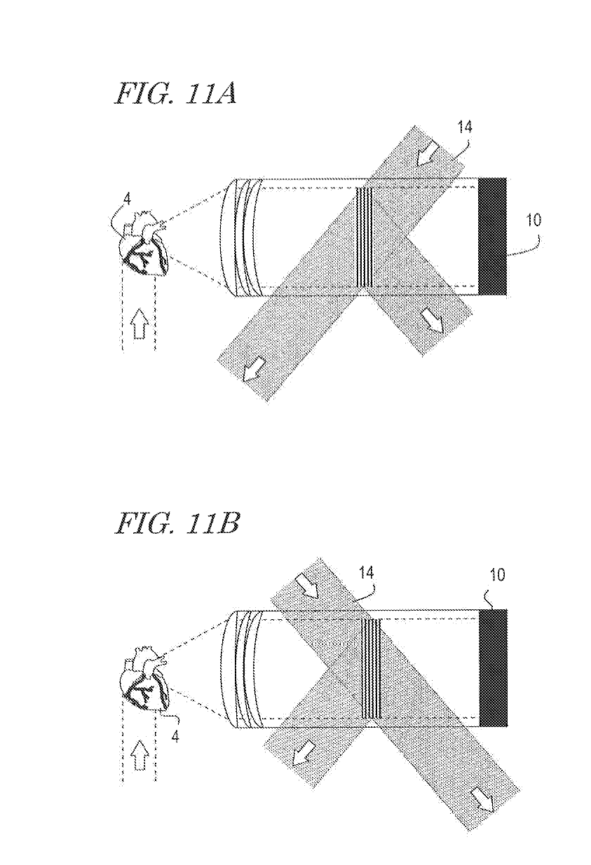

Also, in the embodiment described above, a plane-wave light beam 14 is radiated from the acoustic wave absorbing member 10 toward the subject 4 as shown in FIG. 11A. Alternatively, a plane-wave light beam 14 may also be radiated from the subject 4 toward the acoustic wave absorbing member 10 as shown in FIG. 11B. However, if the plane-wave light beam 14 is radiated as shown in FIG. 11B, the real image obtained will be a mirror image of the real image to be produced with the configuration shown in FIG. 11A. In that case, the former real image will be symmetrical to the latter with respect to the paper on which FIGS. 11A and 11B are drawn. That is why to obtain a real image 18 of the subject 4 in a proper orientation, the image shot needs to be either reflected once by a plane mirror, or processed by the image processing section 20, to produce an optically inverted mirror image.

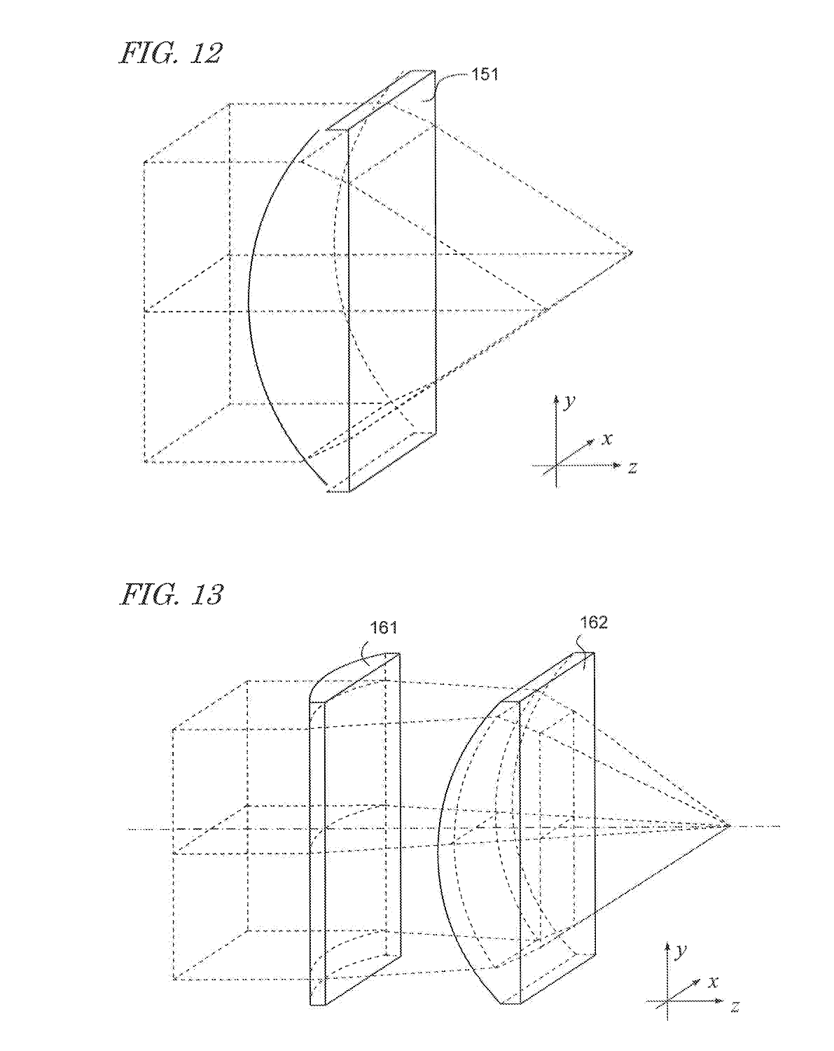

Furthermore, in the embodiment described above, an anamorphic prism 301 is used as the image distortion correcting section 15. However, any other optical system with a similar optical function may be used instead. For example, the image distortion correcting section 15 may also be formed by two condensing cylindrical lenses. As shown in FIG. 12, a cylindrical lens 151 is an optical element which functions as a condenser lens within a plane that is parallel to the yz plane of the coordinate system defined on the drawing but which does not have a condensing function within a plane that is parallel to the xz plane. As shown in FIG. 13, an optical system as a combination of two cylindrical lenses 161 and 162, of which the planes with a light condensing function intersect with each other at right angles, functions as both the image distortion correcting section 15 and as the imaging lens system 16. As shown in FIG. 13, the cylindrical lens 161 condenses light in the zx plane onto a line that is parallel to the y axis, while the cylindrical lens 162 condenses light in the yz plane onto a line that is parallel to the x axis. Since the cylindrical lens 161 has a greater focal length than the cylindrical lens 162, this optical system images the incoming light at two different ratios between the yz and xz planes. If this optical system is arranged in the same direction at the coordinates shown in FIG. 7A, the optical system works fine as the image distortion correcting section 15 of the acousto-optic image capture device 101. More specifically, to correct the oblateness sin θ of the light beam shown in FIG. 3 and to make the ratio of the image in the y-axis direction to the image in the x-axis direction 1/sin θ, the focal lengths of the two lenses are selected. More specifically, the focal lengths are selected so that the focal length of the cylindrical lens 162 becomes sin θ times as long as that of the cylindrical lens 161. In that case, the focal length of the cylindrical lens 161 is determined by the ratio of magnification of the real image 18 to the subject 4.

It should be noted that in the acousto-optic image capture device 101 in which the image distortion correcting section 15 and the imaging lens system 16 are replaced with the optical system shown in FIG. 13, no distortion correction needs to be made by the image processing section 20 as long as the distortion of the cylindrical lenses 161 and 162 is corrected sufficiently.

### Embodiment 2

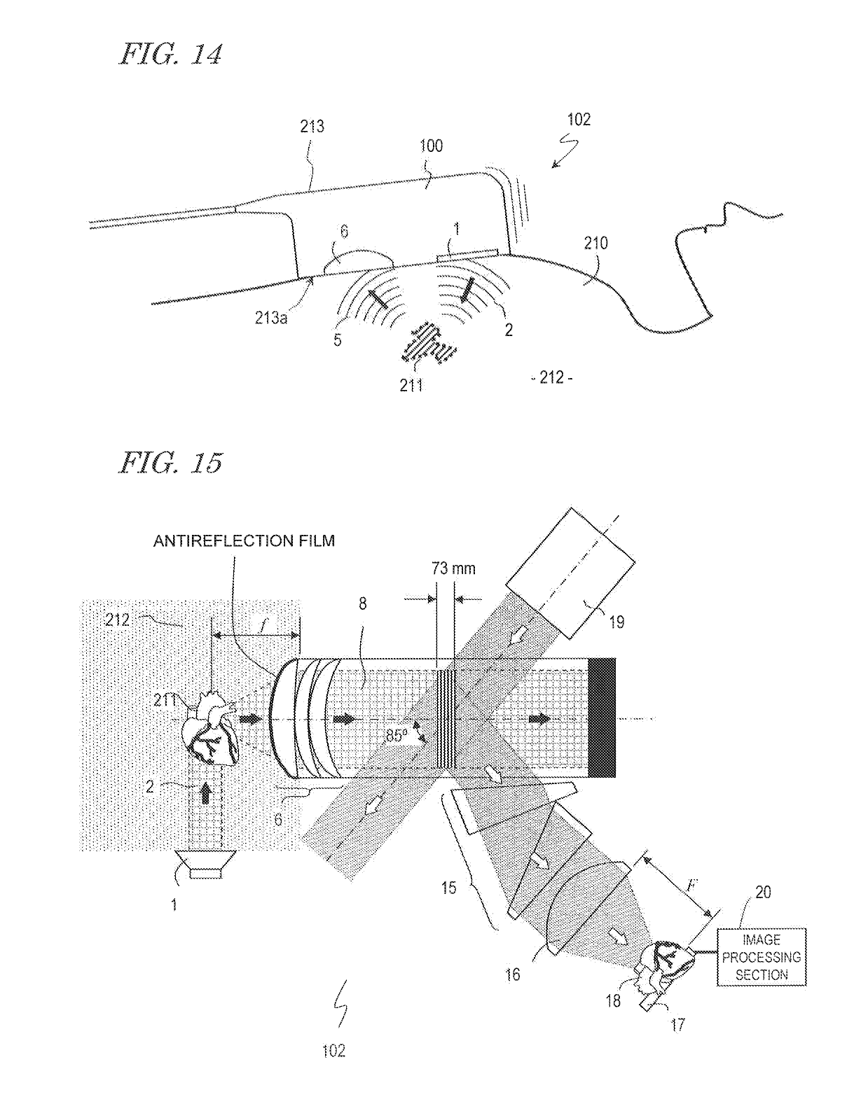

Hereinafter, a second embodiment of an acousto-optic image capture device according to the present invention will be described. FIG. 14 schematically illustrates an acousto-optic image capture device 102 according to this second embodiment. This acousto-optic image capture device 102 captures an image of a person's or animal's internal body organ non-invasively by using an ultrasonic wave as the acoustic wave 2. As shown in FIG. 14, the acousto-optic image capture device 102 has the same configuration as the acousto-optic image capture device 101 of the first embodiment. However, just like a conventional ultrasonic probe, this acousto-optic image capture device 101 includes either everything of the acousto-optic image capture device 101 shown in FIG. 1 or everything but the light source 19 in the probe 213.

As shown in FIG. 14, on the probing surface 213a of the probe 213, arranged are an acoustic wave source 1 and an acoustic lens system 6. As also shown in FIG. 14, in capturing an image, the probing surface 213a of the probe 213 is brought into contact with the body surface of a person under test 210 so that an acoustic wave 2 which has been created from the acoustic wave source 1 outside of his or her body is transmitted inside his or her body. In this case, to reduce reflection and attenuation on the body surface, matching gel, cream or an acoustic impedance matching layer is suitably interposed between the probing surface 213a and the body surface to match the acoustic impedances.

The acoustic wave 2 propagates through his or her body tissue 212 and then gets reflected and scattered from an organ 211 to turn into a scattered wave 5. The scattered wave 5 then reaches the acoustic lens system 6 and is transformed into a plane wave by the acoustic lens system 6. As a result, an image of the organ 211 can be obtained as described for the first embodiment. An image of the organ 211 which is located within a plane that intersects at right angles with the acoustic beam axis 7 (not shown; of the acousto-optic image capture device 102 and outside of the image capturing region can be captured by moving the acousto-optic image capture device 102 on the body surface just like a conventional ultrasonic probe. Also, another organ located at a different depth in the person's body can also be shot by adjusting the focus position with the focal point adjusting mechanism of the acoustic lens system 6 as already described for the first embodiment.

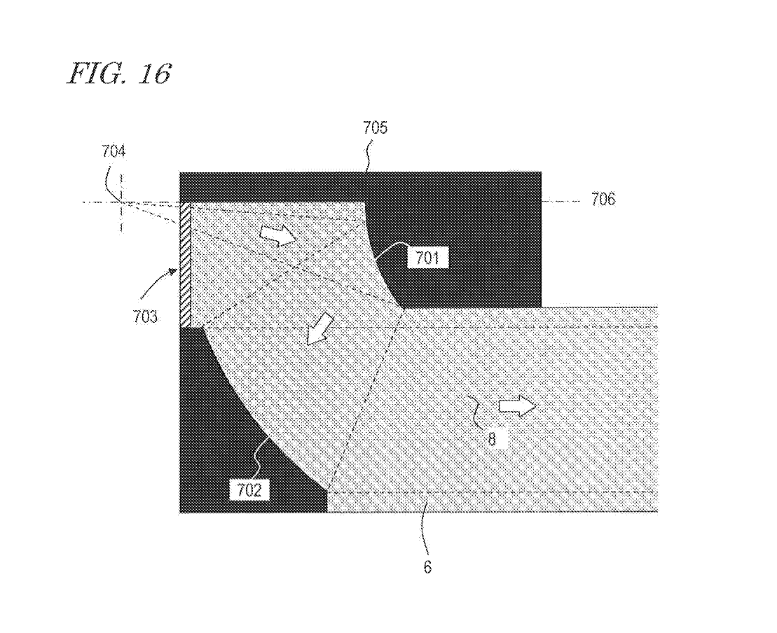

Hereinafter, a specific exemplary configuration to implement such an acousto-optic image capture device 102 will be described with reference to FIG. 15. The acoustic wave source 1 emits a burst signal which may be composed of twenty sin wave pulses with a frequency of 13.8 MHz, for example. This burst signal may have a signal duration of 1.4 μsec, for example. Also, since the speed of sound in the body tissue 212 is approximately 1500 m/s, the ultrasonic sinusoidal wave in the body tissue 212 has a wavelength of approximately 110 μm and the physical signal length of the burst signal as measured parallel to the traveling direction of the ultrasonic wave is approximately 2.2 mm. Consequently, in this case, the organ 211 which is vibrating at a frequency of several hundred kHz at maximum can be shot at a spatial resolution of several hundred μm.

As the acousto-optic medium portion 8, a nanoporous silica with a speed of sound of 50 m/s is used. The nanoporous silica has so low a speed of sound and so short an ultrasonic wave propagation wavelength that a large angle of diffraction can be obtained. In addition, the nanoporous silica is sufficiently transparent with respect to an He—Ne laser beam with a wavelength of 633 nm. Alternatively, fluorinert may also be used effectively as the acousto-optic medium portion 8, because fluorinert is also sufficiently transparent with respect to an He—Ne laser beam with a wavelength of 633 nm and has a speed of sound of about 630 m/s.

If an He—Ne laser with a wavelength of 633 nm is used as the light source 19, the angle of diffraction of the first-order diffracted light becomes 5 degrees. In that case, the beam expansion ratio to be achieved by the image distortion correcting section 15 is approximately 5.74, which is a value that can be corrected by a retailed anamorphic prism.

For safety, an upper limit is put on the acoustic pressure of an acoustic wave that can be radiated inside the body. For that reason, the diffracted light produced often has low light intensity, and therefore, the image receiving section 17 suitably has high sensitivity. Also, in view of image quality and light quantity considerations, in order to capture a real image 18 at the moment when the plane acoustic wave 9 passes through the plane-wave light beam 14 and to monitor the motion of the subject 4 by sequential shooting, it is recommended that an image sensor that can shoot at high speeds be used as the image receiving section 17. For example, a high-speed CCD (charge-coupled device) image sensor may be used as the image receiving section 17. If the luminance of the real image 18 is too low to capture an image easily, an image intensifier may be arranged just before the image sensor to increase the luminance of the real image 18. Alternatively, a light source 11 with an even higher output may be used.

As already described for the acoustic lens system 6, an acoustic wave will be reflected from an interface between two acoustic media with mutually different acoustic impedances to cause a decrease in the intensity or quality of the real image 18. The greater the difference in acoustic impedance at the interface, the more significantly the acoustic wave will be reflected. For that reason, an antireflection film is suitably provided at the interface between the acoustic lens system 6 and the medium 3 as shown in FIG. 15. For example, if the lens of the acoustic lens system 6 that contacts with the medium 3 (body tissue 212) is made of a nanoporous silica with a speed of sound of 50 m/s and a density of 0.11 g/cm³, a quarter-wave antireflection film made of a silica nanopore with a thickness of 6.2 μm, a speed of sound of 340 m/s, and a density of 0.2 g/cm³ is suitably formed on the surface of the lens.

If a real image 18, of which the size is one-fifth of the subject 4, needs to be obtained on the image receiving section 17, then F/f=1.14. As already described for the first embodiment, the real image 18 is (F×λ₀)/(f×λₐ) times as large as the subject 4, the relation (F×λ₀)/(f×λₐ)=1.5 is satisfied. That is why F/f=λₐ/λ₀/5 is satisfied. And if the wavelength of the light (λ₀=633 nm) and the wavelength of the nanoporous silica with a speed of sound of 50 m/s in the acousto-optic medium portion 8 with an ultrasonic wave of 13.8 MHz (λₐ=3.6 μm) are substituted, then F/f=1.14 is obtained. That is why if an acoustic lens system 6 with a focal length of 50 mm is used, then an imaging lens system 16, of which the focal length is 57 mm, will be used (where F=1.14×f=1.14×50 mm).

As already described with reference to FIG. 10, to increase the ratio of magnification (F×λ₀)/(f×λₐ) of the real image 18 to the subject 4, the focal length of the imaging lens system 16 should be increased and the acousto-optic image capture device 102 should have a bigger size. In that case, by using a catoptric optical system such as a Cassegrain optical system as the imaging lens system 16, this problem can be overcome. By adopting such a catoptric optical system, the imaging lens system 16 and the real image 18 can be arranged so that their distance is shorter than the actual focal length F. As a result, the size of the acousto-optic image capture device 102 can be reduced.

Optionally, the size of the acousto-optic image capture device 102 can also be reduced by arranging the acoustic lens system 6 and the imaging lens system 16 so that their distance is shorter than f+F. As already described with reference to FIG. 10, the optical-acoustic mixed optical system of the acousto-optic image capture device 101 can be regarded as a double diffraction optical system in the field of optics. According to the basic arrangement of a double diffraction optical system, the acoustic lens system 6 and the imaging lens system 16 are arranged so as to be spaced apart from each other by the sum (f+F) of the focal lengths of the respective lenses. However, even if the distance between the acoustic lens system 6 and the imaging lens system 16 is set to be a different value from f+F, an optical image formed by the real image 18 is not affected. That is to say, as long as the optical image of the real image 18 is obtained as a light intensity distribution (or unless the phase distribution information of the real image 18 is observed), the distance between the acoustic lens system 6 and the imaging lens system 16 may be shorter than f+F, and the size of the acousto-optic image capture device 102 can be further reduced.

The acousto-optic image capture device 102 of the embodiment described above is supposed to capture an image of a person's or animal's internal body organ internally. However, an acousto-optic image capture device according to the present disclosure may also be implemented as an acousto-optic image capture device for capturing an image of an organ or a vascular wall internally via a catheter, an endoscope or an abdominoscope, for example.

### Embodiment 3

Hereinafter, a third embodiment of an acousto-optic image capture device according to the present invention will be described. The acousto-optic image capture device of this third embodiment is the same as the acousto-optic image capture device 101 of the first embodiment except the configuration of the acoustic lens system 6. Thus, the following description will be focused on only the configuration of the acoustic lens system 6. FIG. 16 illustrates a configuration for the acoustic lens system 6 of this embodiment.

In the first embodiment described above, the entire acoustic lens system 6 is made of a nanopolous silica. If the condition for making a nanopolous silica is adjusted, the speed of sound of an acoustic wave such as an ultrasonic wave in the nanopolous silica can be changed within a wide range, which is one of advantages of the nanopolous silica. The ratio of the speed of sound of the nanopolous silica to that of the medium 3 corresponds to the refractive index of an optical system. That is to say, the nanopolous silica is a flexible acoustic medium which can easily achieve various refractive indices with respect to an ultrasonic wave. That is why if a nanopolous silica is applied as one of the members that form the acoustic lens system 6, then the acoustic lens system 6 can be designed more freely, because the refractive index can be selected from a broad range with respect to an acoustic wave. As a result, the various aberrations can be corrected as well as an ordinary optical lens made up of multiple lens groups, and an acoustic lens system 6 with a wide image circle can be formed. In this description, the “image circle” refers herein to an area on a focal plane where good imaging characteristics are realized.

Although the acoustic lens system 6 of the first embodiment has such advantages, the nanopolous silica need to be joined together and the following problem will arise because of that. For example, even if the acoustic lens system 6 has a single-lens configuration but if a silica nanopore is applied to the acousto-optic medium portion 8 as in the specific example shown in FIG. 15, the nanopolous silica themselves need to be joined together. Also, even if the acoustic lens system 6 has a multi-lens configuration and needs a bonded lens such as an achromat lens in the field of optics, the nanopolous silica themselves need to be joined together, too.

The nanopolous silica and the air have quite different acoustic impedances. That is why to prevent a reflected wave from being created at the junction, it is important to make the nanopolous silica so that no air layer gets trapped in the junction between the nanopolous silica. However, it is very difficult to join the nanopolous silica together while avoiding getting an air layer trapped, considering its manufacturing process. That is why in the acoustic lens system 6 of the first embodiment, it is difficult to prevent a reflected wave from being created at the junction.

To overcome such a problem, the acoustic lens system 6 of this embodiment is implemented as a reflective acoustic system. FIG. 16 is a cross-sectional view of an acoustic lens system 16 as viewed on a plane including the acoustic beam axis 706. The acoustic lens system 6 includes an acoustic waveguide 704 and a primary mirror 702 and a secondary mirror 701 which are arranged as reflective surfaces inside the acoustic waveguide 704. In addition, an acousto-optic medium portion is also arranged inside the acoustic waveguide 704. The acoustic waveguide 704 has a mirror-symmetric structure, which is mirror-symmetric with respect to the paper on which FIG. 16 is drawn. The cross-sectional structure shown in FIG. 16 is rotated 180 degrees on the acoustic beam axis 706. Then, the structure thus rotated is divided on two planes which are parallel to the mirror symmetry plane including the acoustic beam axis 706 so that the mirror symmetry plane is interposed between the two planes. In this manner, the stereoscopic shape of the acoustic waveguide 704 can be obtained. Such an acoustic waveguide 705 may be obtained in this manner. For example, a metallic acoustic waveguide 705 with a reflective surface may be formed by cutting process, for example, an isotropic nanopolous silica may be injected hermetically into the acoustic waveguide thus formed, and then the acousto-optic medium portion 8 and the acoustic lens system 6 are molded together. By performing such a process, an acoustic lens system 6 which can correct aberrations well can be obtained while totally eliminating every junction between nanopolous silica.

A Cassegrain optical system comprised of a primary mirror 702 that is a concave mirror and a secondary mirror 701 that is a convex mirror as shown in FIG. 16 may be used effectively as a reflective optical system according to the present invention. Furthermore, if a Ritchey-Chretien optical system is adopted as the curvature shapes of the primary mirror 702 and secondary mirror 701, the residual aberration of the Cassegrain optical system can be corrected well when the focal length is shortened. As a result, a wide image circle is realized. As a curvature of field is left at the focal point of a Ritchey-Chretien optical system, the interface of the nanopolous silica on the focal point side (i.e., the surface with the antireflection film 703) may be cut into a curved surface so that the interface functions as a correction lens and that the curvature of field is corrected. As the reflective optical system, any other catadioptric optical system such as a Gregory optical system which uses a concave mirror as the secondary mirror 701 or a Schmidt-Cassegrain optical system may also be used.

By using a reflective optical system as the acoustic lens system 6, an acoustic lens system 6, of which the aberration has been well corrected, can be made of only a single nanopolous silica even without joining multiple different kinds of nanopolous silica together, which is usually difficult to get done. Since no reflected waves are created in the vicinity of the acoustic lens system 6, a real image 18 with a high luminance and good image quality can be obtained. Consequently, according to this embodiment, an acousto-optic image capture device which can obtain an image with an even higher luminance and even better image quality is realized.

### Embodiment 4

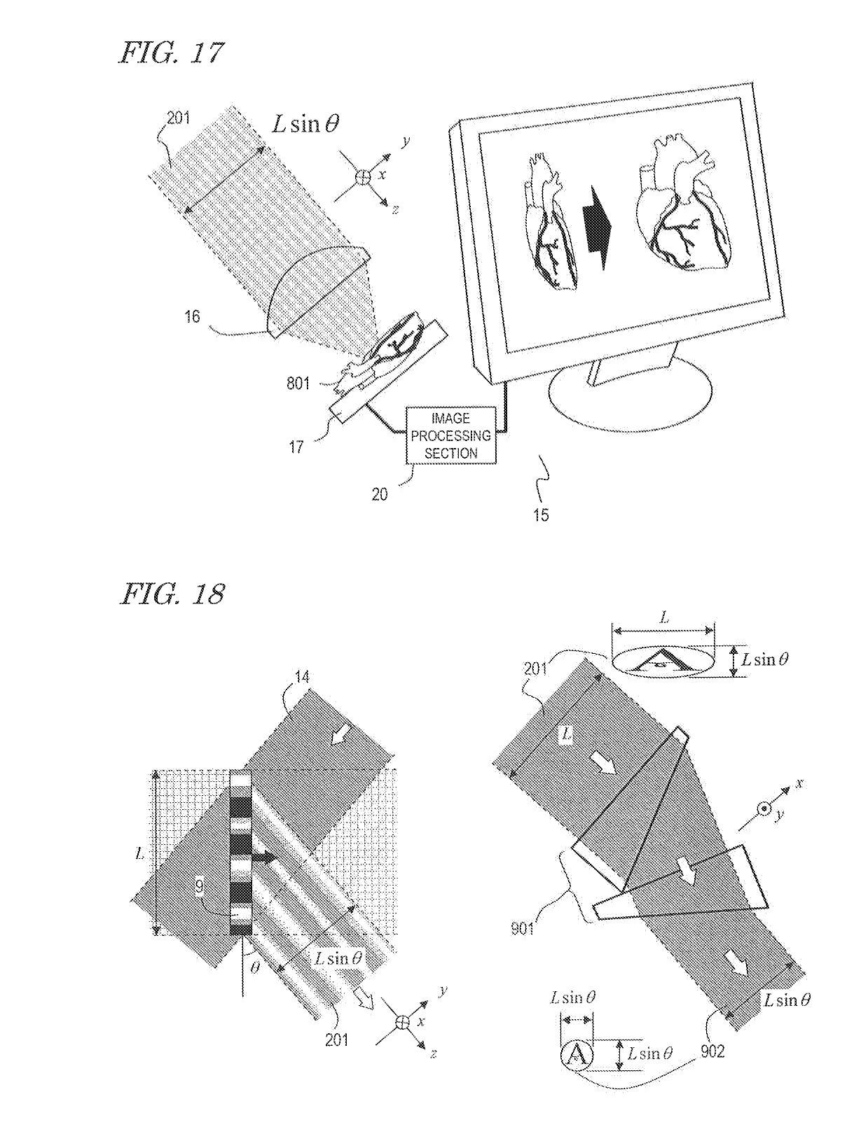

Hereinafter, a fourth embodiment of an acousto-optic image capture device according to the present invention will be described. The acousto-optic image capture device of this fourth embodiment is the same as the acousto-optic image capture device 101 of the first embodiment except that the image distortion correcting section 15 has a different configuration. Thus, the following description of the fourth embodiment will be focused on only the configuration of the image distortion correcting section 15. FIG. 17 schematically illustrates a configuration for the image distortion correcting section 15 of this embodiment.

In the first embodiment described above, the image distortion correcting section 15 includes an optical system including an anamorphic prism and a cylindrical lens. On the other hand, the image distortion correcting section 15 of this embodiment subjects a signal representing the real image 801, which has been obtained by the image receiving section 17, to predetermined processing and makes correction on the real image 801 through image processing.

As shown in FIG. 17, according to this embodiment, the distorted diffracted light 201 is imaged as it is by the imaging lens system 16 without using any anamorphic prisms or cylindrical lenses. In this case, the real image 801 is distorted in the y-axis direction but a real image 801 in that state is gotten as it is by the image receiving section 17. The image processing section 20 receives an electrical signal representing the real image 801 from the image receiving section 17 and removes the image distortion from the real image 801 through image processing. For example, by performing image processing to multiply the real image 801 by 1/sin θ in the y direction on the coordinate system shown in FIG. 17, an image which is similar to the subject 4 is generated.

If the image distortion correcting section 15 of this embodiment is used, then the minimum required number of optical elements to form an acousto-optic image capture device can be reduced. As a result, an acousto-optic image capture device of a reduced size can be provided at a lower cost.

It should be noted that if the angle of diffraction θ is small, the subject 4 is shot so that its image will be significantly expanded in the y-axis direction in the coordinate system defined in FIG. 7 on the image capturing plane of the image receiving section 17. That is why after having been subjected to the image processing, the resolution of the image in the x-axis direction will be different from its resolution in the y-axis direction. In that case, if the acousto-optic image capture device includes both the optical image distortion correcting section 15 shown in FIG. 8 and the image distortion correcting section 15 of this embodiment that performs image processing, the resolutions of the image in the x and y directions can be substantially equal to each other.

Furthermore, if the anamorphic prism 301 is used as the optical image distortion correcting section 15 shown in FIG. 7 and if the image distortion correcting section 15 of this embodiment that performs image processing is also used, then distortion aberration will occur because the angles of incidence of a lot of diffracted rays of light 201 on the anamorphic prism 301 are different from each other. That is why the aberration is also suitably corrected through the image processing of this embodiment.

### Embodiment 5

Hereinafter, a fifth embodiment of an acousto-optic image capture device according to the present invention will be described. The acousto-optic image capture device of this fifth embodiment is the same as the acousto-optic image capture device 101 of the first embodiment except that the image distortion correcting section 15 has a different configuration. Thus, the following description of the fifth embodiment will be focused on only the configuration of the image distortion correcting section 15. FIG. 18 schematically illustrates a configuration for the image distortion correcting section 15 of this embodiment.

Supposing the angle of diffraction of a diffracted ray of light is θ (which is just as defined in the foregoing description), the image distortion correcting section 15 of this embodiment includes an optical reduction system 901 which multiplies the light beam width of the diffracted light 201 by sin θ in the x-axis direction in the coordinate system shown in FIG. 18. If the bundle of plane acoustic waves 9 has a circular cross section with a diameter L, the cross-sectional shape of the bundle of diffracted rays of light 201 becomes an elliptical one, of which the size as measured in the x-axis direction is L and the size as measured in the y-axis direction is L×sin θ. Since the diffracted light 201 is multiplied by sin θ in the x-axis direction by the optical reduction system 901, the cross-sectional shape of the bundle of diffracted rays of light 902 that has been subjected to the distortion correction becomes a circular one, of which the diameter is L×sin θ. Although the image distortion correcting section 15 corrects the diffracted light 201 into a light beam with a diameter L in the first and second embodiments described above, the diffracted light 201 is corrected into a light beam with a diameter L×sin θ according to this embodiment.

As in the first embodiment described above, suppose the focal length of the acoustic lens system 6 is f, the focal length of the imaging lens system 16 is F, the wavelength of the plane acoustic wave 9 which is an ultrasonic wave is λₐ, the wavelength of the plane-wave light beam 14 which is a monochromatic light beam is λ₀, and the angle of diffraction is θ in this embodiment, too. In that case, the cross-sectional shape of the diffracted light beam 902 that has been subjected to the distortion correction will be a circular one, and therefore, the real image 18 will be similar to the subject 4. Also, according to the Fourier optics, their ratio of magnification will be (λₐ×f)/(λ₀×F)×sin θ. However, since Equation (1) needs to be satisfied, the ratio of magnification becomes ½×(f/F) when the diffracted light 201 is +first-order diffracted light.

As can be seen, by adopting this optical reduction system 901, the ratio of magnification no longer depends on the wavelengths of an ultrasonic wave and a monochromatic light beam. That is why if the ratio of the focal lengths of the acoustic lens system 6 and imaging lens system 16 is selected so that f/F=2 is satisfied, a real image 18 of the same size as the subject 4 can be obtained and an image of the subject 4 can be obtained with high resolution. Furthermore, if f is shortened, then F also becomes shorter, and therefore, the overall size of the acousto-optic image capture device can be cut down, too. In addition, since the beam diameter of the distortion-corrected diffracted light 201 becomes narrower, the aperture size of the imaging lens system 16 also becomes smaller, and the overall size of the device can be reduced. In addition, the imaging lens system 16 no longer needs to have high profile irregularity.

In the first and second embodiments described above, the ratio of magnification of the real image 18 to the subject 4 is (F×λ₀)/(f×λₐ). As already described for the specific example shown in FIG. 15, however, the wavelength λₐ of the ultrasonic wave is actually much longer than the wavelength λ₀ of the monochromatic light beam. That is why to obtain a large real image 18, an imaging lens system 16 with a very long focal length needs to be used. As a result, the size of the acousto-optic image capture device 102 should be increased or an imaging lens system 16 with a special optical system structure should be used. On the other hand, according to this embodiment, by using the optical reduction system 901 as the image distortion correcting section 15, a real image 18 can be obtained with high resolution, even though an imaging lens system 16 with a small aperture size and a short focal length is used. In addition, the overall size of the acousto-optic image capture device can be cut down, too.

Even though the optical reduction system 901 is implemented as an anamorphic prism in the embodiment described above, any other optical reduction system with a similar function may also be used.

Also, in the embodiment described above, if the bundle of plane acoustic waves 9 has a circular cross-sectional shape with a diameter L, a distortion-corrected diffracted light beam 902 with a circular beam cross-sectional shape with a diameter L×sin θ is obtained. However, even if correction is made so that the distortion-corrected diffracted light beam 902 has a circular beam cross-sectional shape with a diameter C×L (where C<1), the focal length of the imaging lens system 16 can also be shortened and the image resolution can also be increased. For example, two image distortion correcting sections 15 may be provided and an optical reduction system and an optical magnification system may be used in the x- and y-axis directions, respectively, in the coordinate system shown in FIG. 18. Specifically, in that case, a beam contraction ratio in the x-axis direction and a beam expansion ratio in the y-axis direction may be selected so that the distortion-corrected diffracted light beam 902 has a circular beam cross-sectional shape with a diameter C×L (where C<1).

Optionally, an acousto-optic image capture device including the image distortion correcting section 15 of this embodiment and the image distortion correcting section 15 of the fourth embodiment may also be used. In that case, the beam contraction ratio of the optical reduction system 901 is set so that the distortion-corrected diffracted light 902 has an elliptical beam cross-sectional shape with a size C×L (where C<1) in the x-axis direction and a size L×sin θ in the y-axis direction in the coordinate system defined in FIG. 17. In this manner, the image resolution can be substantially equalized everywhere on the focal plane of the imaging lens system 16.

### Embodiment 6

Hereinafter, a sixth embodiment of an acousto-optic image capture device according to the present invention will be described. The acousto-optic image capture device of this sixth embodiment is the same as the acousto-optic image capture device 101 of the first embodiment except that this embodiment includes angle adjusting sections 1302 and 1303. Thus, the following description of the sixth embodiment will be focused on only the configuration of those angle adjusting sections 1302 and 1303.

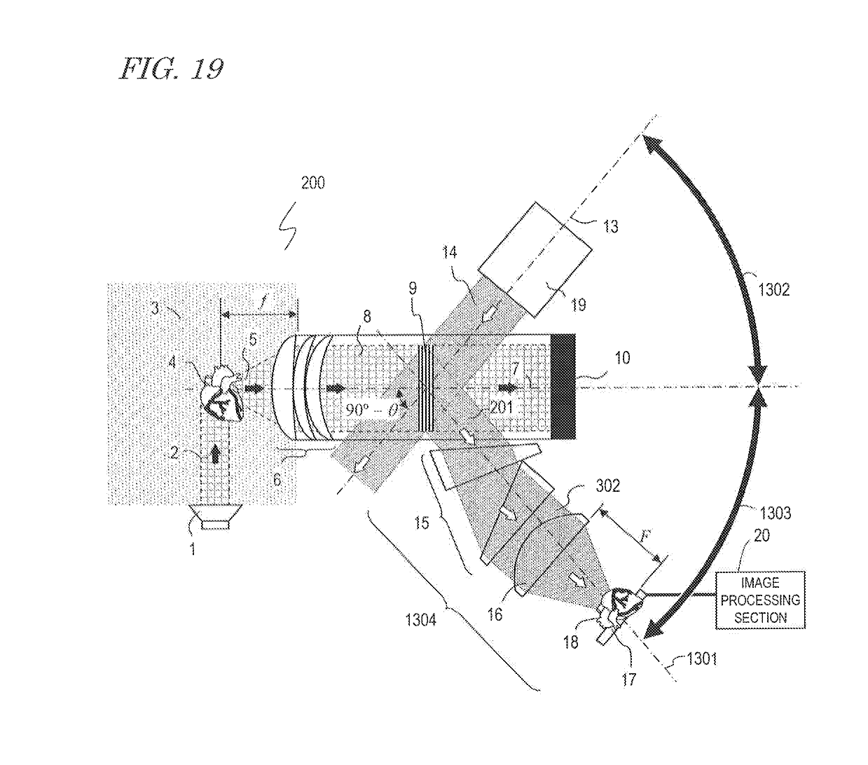

FIG. 19 illustrates a general configuration for the acousto-optic image capture device 106 of this sixth embodiment. This acousto-optic image capture device 106 includes angle adjusting sections 1302 and 1303, which is the only difference from the acousto-optic image capture device 101 of the first embodiment. Thus, description of the other components will be omitted herein. In the following description of this sixth embodiment, any pair of components having substantially the same function as its counterpart of the first embodiment will be identified by the same reference numeral.

As shown in FIG. 19, an optical system consisting of an image distortion correcting section 15, an imaging lens system 16 and an image receiving section 17 will be referred to herein as a “diffracted light imaging optical system 1304”. Also, its optical axis 1301 is in the plane including the acoustic beam axis 7 and the optical axis 13 and is a line which is mirror-symmetric to the optical axis 13 with respect to the acoustic beam axis 7 as the axis of symmetry.

The acousto-optic image capture device 106 of this embodiment includes an angle adjusting section 1302 which adjusts the angle defined by the optical axis 13 of the light source 19 with respect to the acoustic beam axis 7 and an angle adjusting section 1303 which adjusts the angle defined by the optical axis 1301 of the diffracted light imaging optical system 1305 with respect to the acoustic beam axis 7. These two angle adjusting sections 1302 and 1303 operate in conjunction with each other and adjust the angles so that the angle defined by the optical axis 13 with respect to the acoustic beam axis 7 is always equal to the angle defined by the optical axis 1301 with respect to the acoustic beam axis 7.

As already described for the first embodiment, the angle of diffraction 90 degrees−θ defined by the diffracted light 201 with respect to the acoustic beam axis 7 is determined based on the frequency of the sinusoidal wave as the acoustic wave 2 and the wavelength of the light emitted from the monochromatic ray light source 11. That is why even if the frequency of the acoustic wave 2 changes, the acousto-optic image capture device 106 of this embodiment can also shoot the subject 4 by getting the angle of diffraction adjusted by the angle adjusting sections 1302 and 1303.

Since the angle of diffraction can be adjusted, this acousto-optic image capture device 106 can set the frequency of the acoustic wave 2 freely. Thus, a low-resolution image of the subject 4 can be obtained with a low-frequency acoustic wave first, and then a high-resolution image of the subject 4 can be obtained with high definition using a high-frequency acoustic wave. As a result, the shooting session can get done in a shorter time and the size of the image data can be cut down.

### Embodiment 7

Hereinafter, a seventh embodiment of an acousto-optic image capture device according to the present invention will be described. The acousto-optic image capture device of this seventh embodiment includes an acoustic lens system 6′, which is a major difference from the acousto-optic image capture device 101 of the first embodiment. Thus, the following description of the seventh embodiment will be focused on the acoustic lens system 6′.

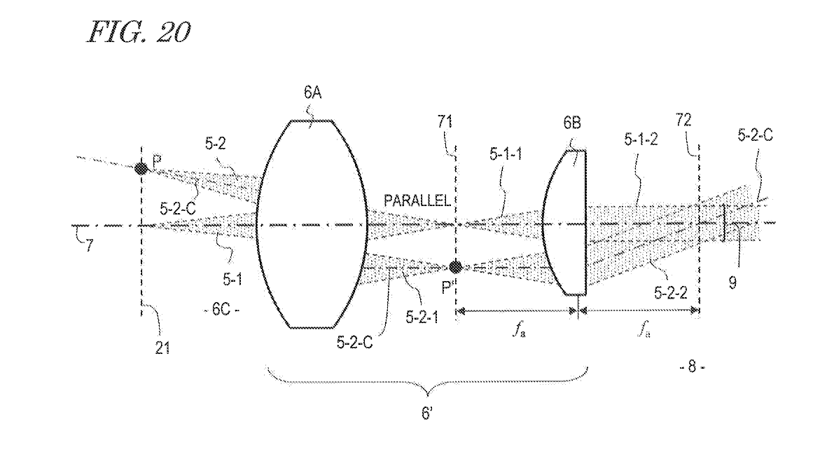

As shown in FIG. 20, the acoustic lens system 6′ includes a telecentric acoustic system 6A and a sound-collecting acoustic system 6B. The telecentric acoustic system 6A is at least image-space telecentric and has a sound-collecting function. That is to say, the telecentric acoustic system 6A makes a parallel acoustic wave converge into a converged acoustic wave. In this description, the “image-space telecentric” is synonymous herein with image-space telecentric in an optical system. The sound-collecting acoustic system 6B is arranged on the image space with respect to the telecentric acoustic system 6A and also has a sound-collecting function. Each of the telecentric acoustic system 6A and the sound-collecting acoustic system 6B is illustrated as being a single acoustic lens in FIG. 20, but may also be implemented as an acoustic element comprised of multiple acoustic lenses, for example. Each acoustic lens is an elastic body having the shape of an optical lens. The elastic body is suitably a material that will cause little acoustic transmission loss to the acoustic wave 2.

The telecentric acoustic system 6A and sound-collecting acoustic system 6B of the acoustic lens system 6′ may be provided in either the acoustic medium portion 8 or a low loss medium 6C. The low loss medium 6C is suitably a material that will cause little acoustic transmission loss to the acoustic wave. It should be noted that if the speed of sound of the telecentric acoustic system 6A and sound-collecting acoustic system 6B is lower than that of the low loss medium 6C, the telecentric acoustic system 6A and sound-collecting acoustic system 6B may include an acoustic element in the shape of a convex lens to have a converging function. Conversely, if the speed of sound of the telecentric acoustic system 6A and sound-collecting acoustic system 6B is higher than that of the low loss medium 6C, the telecentric acoustic system 6A and sound-collecting acoustic system 6B may include an acoustic element in the shape of a concave lens to have a converging function. The telecentric acoustic system 6A and the sound-collecting acoustic system 6B may be designed by adopting ray tracing or any other design method in the field of optics so that the acoustic lens system 6′ will have a good imaging characteristic.

If this acousto-optic image capture device is used as an ultrasonic diagnostic apparatus, either water or a fluorine base solvent such as fluorinert may be used as the low loss medium 6C, and acoustic elements that form the telecentric acoustic system 6A and the sound-collecting acoustic system 6B may be made of a low acoustic loss resin material such as polystyrene. To prevent the scattered wave 5 from being reflected and causing attenuation or multi-reflection due to a difference in density or speed of sound at the interface between the telecentric acoustic system 6A, the sound-collecting acoustic system 6B and the low loss medium 6C, at the interface between the acoustic lens system 6′ and the medium 3, and at the interface between the acoustic lens system 6′ and the acoustic medium portion 8, the telecentric acoustic system 6A and the sound-collecting acoustic system 6B may be provided with an acoustic wave antireflection film. For example, a film of which the acoustic impedance is the average of the squared acoustic impedances of the two kinds of materials that are adjacent to each other at the interface described above (i.e., the interface between the low loss medium 6C, the medium 3 and the acoustic medium portion 8 and the telecentric acoustic system 6A and the sound-collecting acoustic system 6B) and of which the thickness is a quarter wave of the acoustic wave 2 may be provided as an antireflection film. Also, as in the field of optics, a multilayer antireflection film may also be used.

As shown in FIG. 20, the acoustic axes of the telecentric acoustic system 6A and sound-collecting acoustic system 6B not only agree with each other but also agree with the acoustic beam axis 7 of the acoustic lens system 6′ as well. The distance between the telecentric acoustic system 6A and the sound-collecting acoustic system 6B is set to be equal to the sum of the respective focal lengths of the telecentric acoustic system 6A and the sound-collecting acoustic system 6B. That is why the imaging plane of the telecentric acoustic system 6A agrees with one of imaging planes 71 of the sound-collecting acoustic system 6B. The other focal point (i.e., the other imaging plane 72) of the sound-collecting acoustic system 6B is located in a region of the acousto-optic medium portion 8 through which the light beam 14 emitted from the light source 19 is transmitted. The other focal point of the telecentric acoustic system 6A agrees with the focal plane 21 of the acoustic lens system 6′.

Next, it will be described how the acoustic lens system 6′ converges the scattered wave 5. As shown in FIG. 20, the scattered wave 5 which reflects the elastic property of the subject 4 at the focal plane 21 is incident on the telecentric acoustic system 6A of the acoustic lens system 6′. In this scattered wave 5, the scattered wave 5-1 reflected from the point on the acoustic beam axis 7 on the focal plane 21 becomes a scattered wave 5-1-1 which is converged by the telecentric acoustic system 6A toward a point at which the acoustic beam axis 7 intersects with the imaging plane 71 and then diverges. On the other hand, the scattered wave 5-2 reflected from a point P which is located on the focal plane 21 off the acoustic beam axis 7 is turned by the telecentric acoustic system 6A into a scattered wave 5-2-1, converges at the imaging plane 71 to produce an image P′ there, and then diverges. The chief ray 5-2-C of the scattered wave 5-2-1 is parallel to the acoustic beam axis 7 as shown in FIG. 20. In this description, the chief ray 5-2-C is defined for each of the bundles of acoustic rays on the incoming and outgoing sides of the scattered wave to be transmitted through the telecentric acoustic system 6A and refers herein to the acoustic line that passes through the center of the bundle of acoustic rays of the scattered wave that goes out of an arbitrary point P on the focal plane 21 and then is incident on the telecentric acoustic system 6A to produce an image P′.

As in telecentric in an optical system, the scattered wave 5-2 reflected from the point P which is located on the focal plane 21 off the acoustic beam axis 7 is transformed by the telecentric acoustic system 6A into a scattered wave 5-2-1 including a chief ray 5-2-C that is parallel to the acoustic line 7. Since the imaging plane 71 is located at the focal length fa of the sound-collecting acoustic system 6B, the scattered waves 5-1-1 and 5-2-1 that have converged toward the imaging plane 71 and then diverged are transformed by the sound-collecting acoustic system 6B into parallel acoustic waves 5-1-2 and 5-2-2. In this case, the chief ray 5-2-C of the parallel acoustic wave 5-2-2 intersects with the acoustic beam axis 7 on the imaging plane 72. As can be seen, by adopting the acoustic lens system 6′ of this embodiment, the scattered wave 5-2 reflected from the point P on the focal plane 21 away from the acoustic beam axis 7 is transformed into a parallel acoustic wave 9 so that the chief ray 5-2-C intersects with the acoustic beam axis 7 on the imaging plane 72. That is why the propagation area of the plane acoustic wave 9 is small on a plane that intersects at right angles with the traveling direction of the plane acoustic wave 9 (i.e., on a plane that intersects at right angles with the acoustic beam axis 7) and its acoustic pressure has been raised.

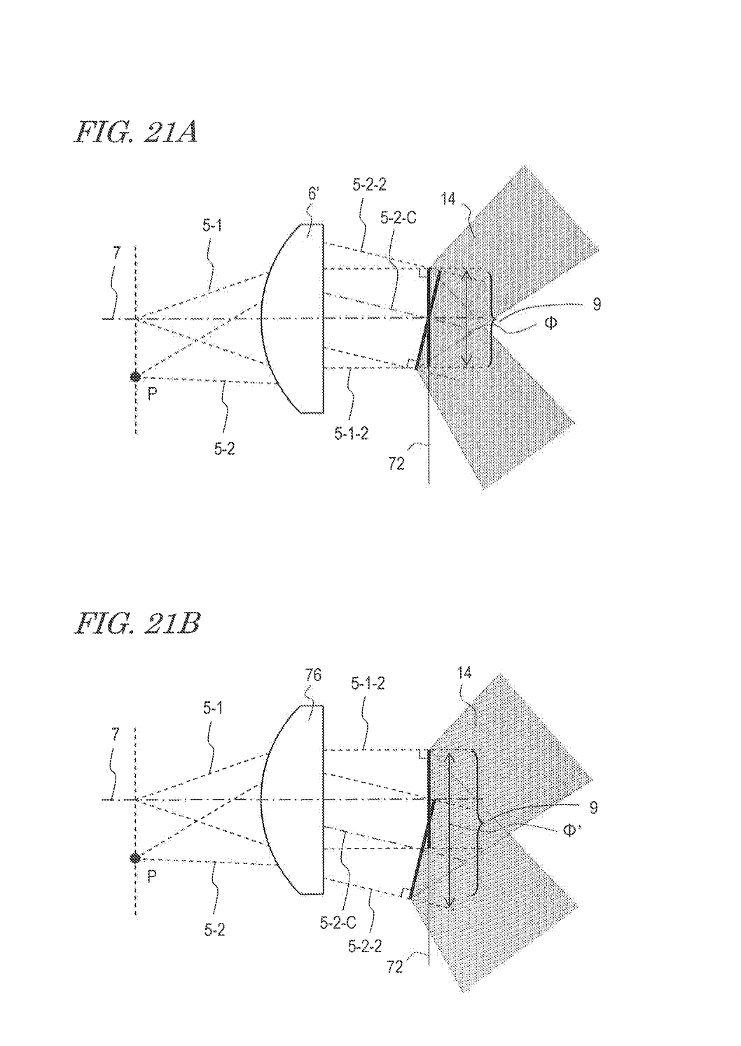

FIG. 21A illustrates a relation between a scattered wave that has entered the acoustic lens system 6′ and a plane acoustic wave 9 that has gone out of the acoustic lens system 6′. As shown in FIG. 21A, in the acoustic lens system 6′ for use in this embodiment, the scattered wave 5-2 that has been reflected from the point P on the focal plane 21 away from the acoustic beam axis 7 is transformed into a parallel acoustic wave 5-2-2 so that its chief ray 5-2-C intersects with the acoustic beam axis 7 on the imaging plane 72 as described above. And the parallel acoustic wave 5-2-2 overlaps, on the imaging plane 72, almost entirely with the parallel acoustic wave 5-1-2 into which the scattered wave 5-1 on the acoustic beam axis 7 has been transformed. As a result, the diameter 4) of the plane acoustic wave 9 can be reduced. On the other hand, if the acoustic lens system 6′ included no image-space telecentric acoustic elements, the chief ray 5-2-C of the scattered wave 5-2 reflected from the point. P on the focal plane 21 away from the acoustic beam axis 7 would be transformed into a parallel acoustic wave 5-2′-2 that does not intersect with the acoustic beam axis 7 on the imaging plane 72 as shown in FIG. 21B. As a result, the diameter Φ of the plane acoustic wave 9 would increase on the imaging plane 72.

As already described for the first embodiment, to shoot the subject 4, the entire plane wave 9 is suitably irradiated with the plane-wave light beam 14. Comparing FIGS. 21A and 21B to each other, it can be seen that the subject 4 can also be shot according to this embodiment even with the plane-wave light beam 14 with a small diameter. As a result, the size of the light source 19 can be reduced. In addition, since the entire plane wave 9 can be easily irradiated with the plane-wave light beam 14 at a uniform intensity, a more uniform image can be obtained.

In addition, the acousto-optic image capture device of this embodiment that uses the acoustic lens system 6′ can be used effectively to shoot a large subject 4 such as an abdominal cavity tissue. To shoot a large subject 4 corresponds to shooting the subject 4 at a wide angle. To shoot the subject 4 at a wide angle using a conventional ultrasonic diagnostic apparatus, ultrasonic waves need to be transmitted and received in a broad range by either moving the probe or changing its orientation. Also, as already described with reference to FIG. 21B, if the acoustic lens system 6′ included no image-space telecentric acoustic elements, the diameter Φ′ of the plane acoustic wave 9 would increase on the imaging plane 72. That is why if the scattered wave 5 coming from the subject 4 were received at a wide angle, then the diameter Φ′ of the plane acoustic wave 9 would further increase on the imaging plane 72. For that reason, the size of the light source 19 would increase too much or no uniform image could be obtained anymore. In contrast, since the diameter Φ′ of the plane acoustic wave 9 on the imaging plane 72 can be reduced according to this embodiment, such a large subject 4 can be shot effectively or the subject 4 can be shot effectively at such a wide angle.

If a subject 4 located at a different distance is going to be shot using the acousto-optic image capture device including the acoustic lens system 6′, the focal plane 21 needs to be translated along the acoustic beam axis 7. For that purpose, the acoustic lens system 6′ may further include a moving mechanism for translating the telecentric acoustic system 6A along the acoustic beam axis 7 so that the telecentric acoustic system 6A forms focal points on the focal plane moved 21 and on the imaging plane 71 of the sound-collecting acoustic system 6B (which has not moved). As a result, the subject 4 located at a different distance can be shot without changing the position of the imaging plane 72.

Optionally, the acoustic lens system 6′ may have a zoom function which is adopted in a lens for an optical camera, i.e., the function of varying the size of the real image 18 with respect to the subject 4. In that case, one or both of the telecentric acoustic system 6A and the sound-collecting acoustic system 6B is/are provided with a mechanism for changing the focal length (i.e., a focal, length adjusting mechanism). More specifically, the focal length adjusting mechanism refers herein to a mechanism for changing the relative distance of two or more single lenses, each having a fixed focal length. By changing the relative distance of two or more single lenses, the composite focal length is changed to realize the zoom function. Those two or more single lenses may be either concave lenses or convex lenses. In any case, the acoustic lens system 6′ just needs to have the condensing function as a whole by using those multiple single lenses.

If the telecentric acoustic system 6A has the zoom function, the image-space focal point of the telecentric acoustic system 6A is set on the imaging plane 72 of the sound-collecting acoustic system 6B in order to prevent the real image 18 from getting blurred due to zooming. For that purpose, not only the mechanism for changing the relative distance between the lenses but also a mechanism for moving the telecentric acoustic system 6A in its entirety may be provided.

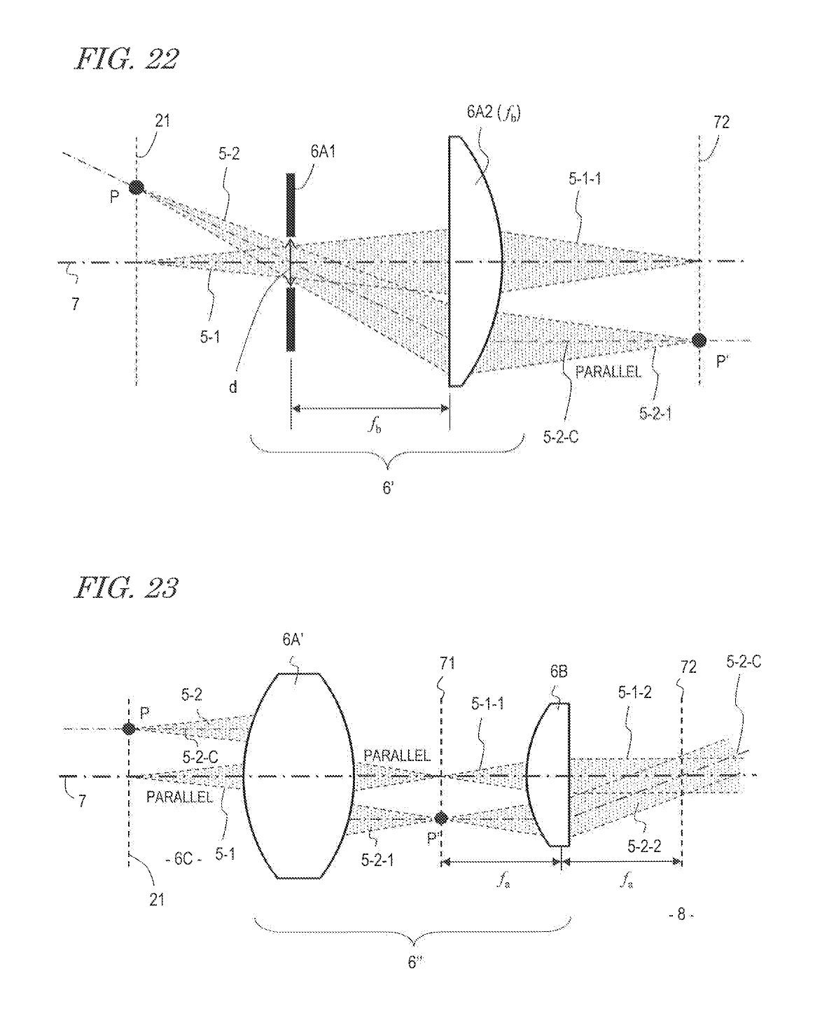

An example of the telecentric acoustic system 6A is shown in FIG. 22. The telecentric acoustic system 6A may be comprised of a diaphragm 6A1 and a sound-collecting lens 6A2, for example. The sound-collecting lens 6A2 has a focal length fb and the diaphragm 6A1 is arranged at one of the two focal points of the lens 6A2. And the interval between the sound-collecting lens 6A2 and the sound-collecting acoustic system 6B is adjusted so that the other focal point is located on the imaging plane 72. The diaphragm 6A1 and the sound-collecting lens 6A2 both have rotation symmetry with respect to the acoustic beam axis 7. The aperture diameter d of the diaphragm 6A1 is set so as to prevent a spherical wave created on the outermost periphery of the shooting area on the focal plane 21 from being affected by so-called “vignetting” caused by the sound-collecting lens 6A2. Even though the sound-collecting lens 6A2 is illustrated as a single lens in FIG. 22, the sound-collecting lens 6A2 may also be comprised of multiple lenses as well.

In the acousto-optic image capture device of the embodiment described above, the acoustic lens system 6′ includes a telecentric acoustic system 6A which is single telecentric. However, the acoustic lens system 6′ may also include a telecentric acoustic system which is double telecentric. Specifically, as shown in FIG. 23, in the acousto-optic image capture device of this embodiment, the acoustic lens system 6″ includes a telecentric acoustic system 6A′ which is double telecentric and the sound-collecting acoustic system 6B. In that case, in the telecentric acoustic system 6A′ which is double telecentric, not only the scattered wave 5-2-1 going out of the telecentric acoustic system 6A′ but also the chief ray 5-2-C of the scattered wave 5-2 to be incident on the telecentric acoustic system 6A from the point P which is distant from the acoustic beam axis 7 are parallel to the acoustic beam axis 7 as shown in FIG. 23. Even in such an embodiment, the effects achieved by the telecentric acoustic system 6A described above can also be achieved.

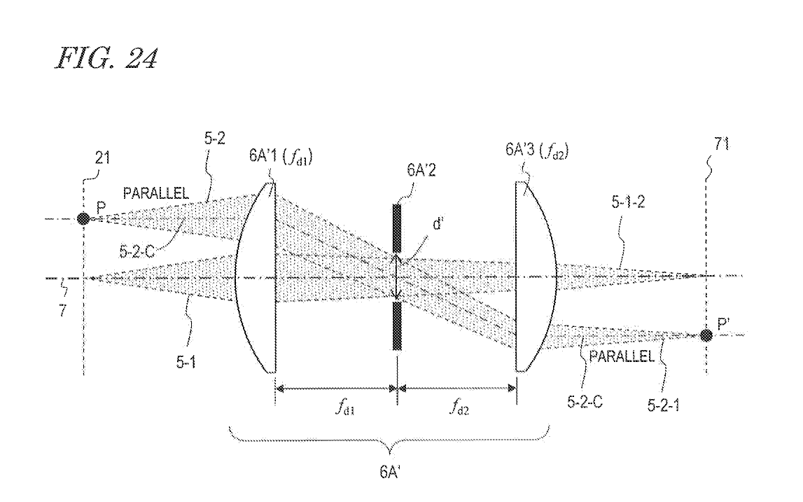

An example of the telecentric acoustic system 6A′ is shown in FIG. 24. The telecentric acoustic system 6A′ may be comprised of a sound-collecting lens 6A′1 with a focal length fd1, a diaphragm 6A′2 and a sound-collecting lens 6A′3 with a focal length fd2, for example. These three elements have rotation symmetry with respect to the acoustic beam axis 7. The sound-collecting lenses 6A′1 and 6A′3 and the diaphragm 6A′ 2 are arranged so that the diaphragm 6A′2 is located at the focal points of the sound-collecting lenses 6A′1 and 6A′3. And the interval between the sound-collecting lens 6A′3 and the sound-collecting acoustic system 6B is adjusted so that the other focal point of the sound-collecting lens 6A′3 is located on the imaging plane 71. The aperture diameter d′ of the diaphragm 6A′2 is set so as to prevent a spherical wave created on the outermost periphery of the shooting area on the focal plane 21 from being affected by so-called “vignetting” caused by the sound-collecting lenses 6A′1 and 6A′3. Even though the sound-collecting lenses 6A′1 and 6A′3 are illustrated as single lenses in FIG. 24, each of these sound-collecting lenses 6A′1 and 6A′3 may also be comprised of multiple lenses as well. The focal lengths of the sound-collecting lenses 6A′1 and 6A′3 may be equal to each other or may be different from each other.

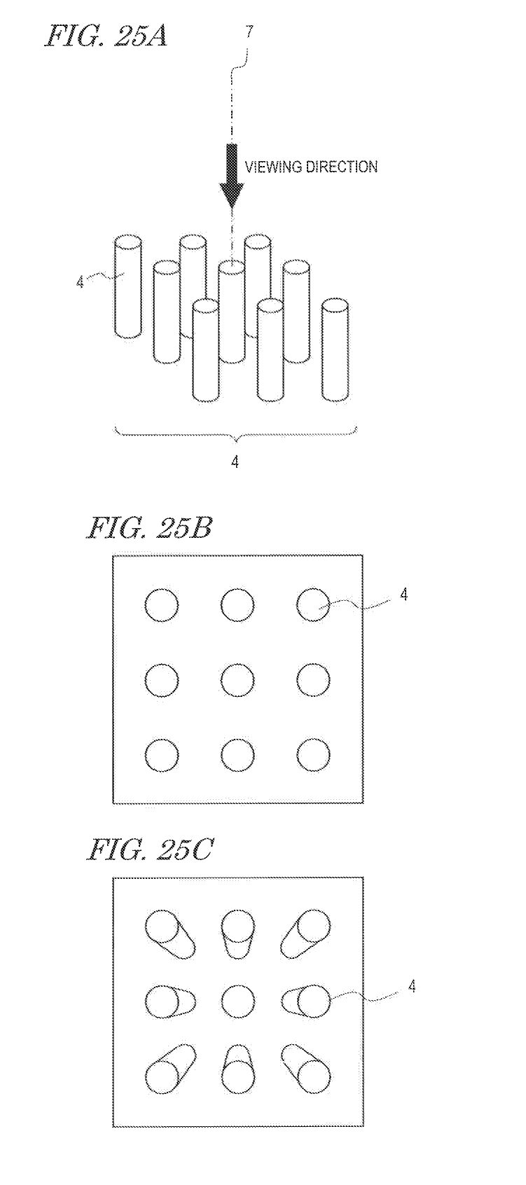

Next, images obtained by an acousto-optic image capture device including the telecentric acoustic system 6A and by an acousto-optic image capture device including the telecentric acoustic system 6A′ will be described with reference to FIG. 25.

Suppose a situation where the subject 4 includes a number of circular cylinders that run parallel to the acoustic beam axis 7 as shown in FIG. 25A. When viewed on a plane which intersects at right angles with the acoustic beam axis 7, those circular cylinders are arranged in three columns and three rows. In that case, the subject image to be obtained by an acousto-optic image capture device including the telecentric acoustic system 6A′ which is double telecentric includes only respective parts of the subject 4 that appear on the plane that intersects at right angles with the acoustic beam axis 7 as shown in FIG. 25B. That is to say, the subject 4 as viewed from the infinity in the direction of the acoustic beam axis 7 will be shot. On the other hand, the subject image to be obtained by an acousto-optic image capture device including the telecentric acoustic system 6A which is single telecentric includes the center circular cylinder surrounded with the eight other radially arranged circular cylinders of the three by three matrix pattern. That is to say, the side surfaces of those eight circular cylinders other than the center one will be shot. The difference in the images to be obtained by two such acoustic systems becomes more significant when the subject 4 is shot from multiple different positions in the acoustic lens system to generate a three-dimensional image.

As shown in FIG. 25C, in the case of an acousto-optic image capture device including the telecentric acoustic system 6A which is single telecentric, the size of an image obtained varies according to the distance between the subject 4 and the telecentric acoustic system 6A, and the ratio of magnification of an image shot to the object of shooting depends on the distance between the telecentric acoustic system 6A and the subject 4. That is why in reconstructing a three-dimensional structure, the ratios of magnification of images shot need to be matched to each other.

On the other hand, in the case of an acousto-optic image capture device including the telecentric acoustic system 6A′ which is double telecentric, the size of an image shot is constant irrespective of the distance between the subject 4 and the telecentric acoustic system 6A′. That is why a three-dimensional structure can be reconstructed even without matching the ratios of magnification of images shot to each other. Consequently, by adopting such an acousto-optic image capture device including the telecentric acoustic system 6A′ which is double telecentric, a three-dimensional image can be constructed with reduced image processing.

Although first through seventh embodiments of an acousto-optic image capture device according to the present invention have been described, the present invention is in no way limited to those specific embodiments but may also be modified in various manners. In addition, any combination of the first through seventh embodiments is also included in various embodiments of an acousto-optic image capture device according to the present invention. More specifically, an acousto-optic image capture device may be implemented as any arbitrary combination of two or more of the first through seventh embodiments except the combination of the second and seventh embodiments.

An acousto-optic image capture device according to the present invention can obtain an ultrasonic image to be used in various applications as an optical image, and therefore, can be used effectively as a probe for an ultrasonic diagnostic apparatus, for example. Also, if the inside of an object that light cannot reach is going to be shot and if the object is made of a material that can propagate an ultrasonic wave, the distribution of moduli of elasticity inside the object can be observed as an optical image. That is why the acousto-opt ic image capture device can also be used as a non-destructive oscillometer, for example. Furthermore, since the acousto-optic image capture device can capture images at high speeds, the acousto-optic Image capture device of the present invention can be used as a non-destructive oscillometer which measures the magnitude of motion by a non-contact method.

While the present invention has been described with respect to exemplary embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. An acousto-optic image capture device comprising:
an acoustic wave source;
an acoustic lens system configured to transform a scattered wave created by irradiating a subject with an acoustic wave that has been emitted from the acoustic wave source into a predetermined converged state;
an acousto-optic medium portion arranged so that the scattered wave that has been transmitted through the acoustic lens system is incident on the acousto-optic medium portion;
a light source configured to emit a light beam in which a plurality of monochromatic rays of light with mutually different traveling directions are superposed one upon the other and which is incident on the acousto-optic medium portion at an angle with respect to, and neither perpendicularly nor parallel to, the acoustic beam axis of the acoustic lens system;
an imaging lens system configured to condense diffracted rays of light of the plurality of plane wave monochromatic rays of light that have been produced by the acousto-optic medium portion; and
an image receiving section configured to detect the rays of light that have been condensed by the imaging lens system and output an electrical signal,
wherein the acoustic lens system includes at least a telecentric acoustic system that is image-space telecentric and a sound-collecting acoustic system that is arranged on the image space,
the distance between the telecentric acoustic system and the sound-collecting acoustic system is equal to the sum of the respective focal lengths of the telecentric acoustic system and the sound-collecting acoustic system, and the light beam is transmitted at the focal point of the sound-collecting acoustic system through the acousto-optic medium portion.

2. The acousto-optic image capture device of claim 1, wherein the telecentric acoustic system includes at least one sound-collecting lens, and a diaphragm that is arranged on object side with respect to the sound-collecting lens.

3. The acousto-optic image capture device of claim 1, wherein the telecentric acoustic system is double telecentric.

4. The acousto-optic image capture device of claim 3, wherein the telecentric acoustic system includes first and second sound-collecting lenses and a diaphragm that is arranged between the first and second sound-collecting lenses.

5. The acousto-optic image capture device of claim 1, further comprising an image distortion correcting section configured to correct the distortion of the diffracted rays of light and/or the subject image represented by the electrical signal.

6. The acousto-optic image capture device of claim 5, wherein the monochromatic rays of light have a spectrum width of less than 10 nm and are plane waves, of which the wavefront accuracy is ten times or less of the wavelength at the center frequency of the monochromatic rays of light.

7. The acousto-optic image capture device of claim 1, wherein the acoustic lens system is made of a nanopolous silica or fluorinert.

8. The acousto-optic image capture device of claim 1, wherein the acoustic lens system includes a focal length adjusting mechanism.

9. The acousto-optic image capture device of claim 1, wherein the imaging lens system includes a focal length adjusting mechanism.

10. The acousto-optic image capture device of claim 1, wherein the light source includes a plurality of fly-eye lenses.

11. The acousto-optic image capture device of claim 1, wherein the image distortion correcting section includes an optical member which increases the cross-sectional area of the diffracted rays of light.

12. The acousto-optic image capture device of claim 1, wherein the image distortion correcting section includes an optical member that decreases the cross-sectional area of the diffracted rays of light.

13. The acousto-optic image capture device of claim 11, wherein the optical member is implemented as an anamorphic prism.

14. The acousto-optic image capture device of claim 11, wherein at least one of the imaging lens system and the optical member includes at least one cylindrical lens.

15. The acousto-optic image capture device of claim 1, wherein the image distortion correcting section is configured to perform image processing based on the electrical signal.

16. The acousto-optic image capture device of claim 1, wherein the acousto-optic medium portion includes at least one of a nanopolous silica, fluorinert and water.

17. The acousto-optic image capture device of claim 1, wherein the diffracted rays of light include Bragg diffracted light components that account for a half or more by intensity ratio.

18. The acousto-optic image capture device of claim 1, wherein the optical axis of the light beam emitted from the light source is adjustable with respect to the acoustic beam axis of the acoustic lens system.

19. The acousto-optic image capture device of claim 1, wherein the acoustic wave is a pulsed one.
